(19) United States
(12) Patent Application Publication
(10) Pub. No.: US 2026/0228139 A1
(43) Pub. Date: Aug. 6, 2026

(54) ASYMMETRIC PARTIAL LINK WIDTH STATE MANAGEMENT

(71) Applicants: Debendra Das Sharma, Saratoga, CA (US); Michelle C. Jen, Los Altos, CA (US)

(72) Inventors: Debendra Das Sharma, Saratoga, CA (US); Michelle C. Jen, Los Altos, CA (US)

(21) Appl. No.: 19/632,150

(22) Filed: Mar. 27, 2026

Related U.S. Application Data
(60) Provisional application No. 63/928,311, filed on Dec. 1, 2025.

(51) Int. Cl. G06F 13/16

(52) U.S. Cl. CPC G06F 13/1626; G06F 2213/0026

(57) ABSTRACT

A port is used to couple to another device over an interconnect, where the port generates a request to change a link width of a bidirectional link and includes a first link direction to send data to the other device and a second link direction to receive data from the other device. The port sends the request to the other device over the interconnect and sends a signal on a subset of lanes of the link in the first link direction in association with the request to change the link width of the link, where the subset of lanes are to be added to or subtracted from the link width of the link based on the request.

### RELATED APPLICATION

This application claims benefit to U.S. Provisional Patent Application Ser. No. 63/928,311, filed Dec. 1, 2025, which is incorporated by reference herein in its entirety.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of an interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates a first device coupled to a second device by an example link.

FIG. 6 is a simplified block diagram illustrating ports of a bidirectional link.

FIGS. 7A-7C are simplified block diagrams illustrating an example link widths of a link.

FIG. 8 is a diagram illustrating example signaling in a first link width adjustment.

FIG. 9 is a diagram illustrating example signaling in a second link width adjustment.

FIG. 10 illustrate example signaling on lanes of an example link associated with a link width adjustment.

FIG. 11 illustrate example signaling on lanes of an example link associated with another link width adjustment.

FIG. 12 illustrate example signaling on lanes of an example link associated with yet another link width adjustment.

FIGS. 13A-13B illustrate example signaling on lanes of an example link associated with a link width adjustment from the perspective of a transmitter and a receiver.

FIG. 14 is a diagram illustrating example signaling in a third example link width adjustment.

FIG. 15 is a diagram illustrating example signaling in a fourth example link width adjustment.

FIG. 16 is a diagram illustrating example signaling in a fifth example link width adjustment.

FIG. 17 is a diagram illustrating example signaling in a sixth example link width adjustment.

FIG. 18 is a diagram illustrating example signaling in a seventh example link width adjustment.

FIG. 19 is a diagram illustrating a first example state machine.

FIG. 20 is a diagram illustrating a second example state machine.

FIG. 21 illustrates an embodiment of a block diagram for a computing system including a multicore processor.

FIG. 22 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages, and operation etc. in order to provide a thorough understanding of the present disclosure. It will be apparent, however, to one skilled in the art that these specific details need not be employed to practice the principles and solutions discussed in this disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems and may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers, set-top boxes, network hubs, wide area network (WAN) switches, or any other system that can perform the functions and operations taught below. Moreover, the apparatus,' methods, and systems described herein are not limited to physical computing devices, but may also relate to software optimizations for energy conservation and efficiency.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet it is a singular purpose of most fabrics to provide highest possible performance with maximum power saving. Below, a number of interconnects are discussed, which would potentially benefit from aspects of the solutions described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; clients (desktops and mobile), servers (standard and enterprise), and embedded and communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power management, quality of service (QoS), hot-plug/hot-swap support, data integrity, and error handling are among some of the advanced features supported by PCIe.

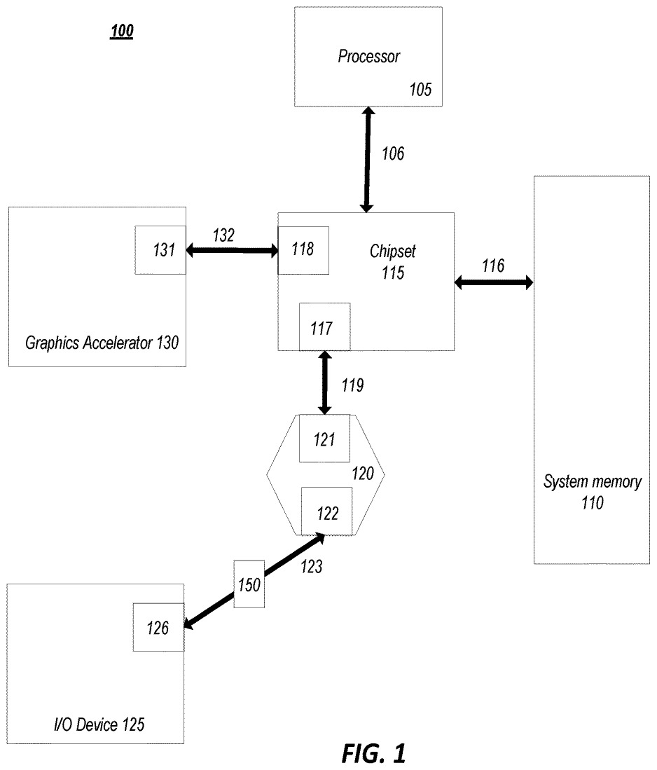

Referring to FIG. 1, an embodiment of a fabric composed of point-to-point Links that interconnect a set of components is illustrated. System 100 includes processor 105 and system memory 110 coupled to chipset 115. Processor 105 is coupled to chipset 115 through a high-speed serial interface link 106. In one embodiment, link 106 is a serial point-to-point interconnect as described below. In another embodiment, link 106 includes a serial, differential interconnect architecture that is compliant with different interconnect standards.

System memory 110 includes any memory device, such as random access memory (RAM), non-volatile (NV) memory, solid state memory, or other memory accessible by devices in system 100. System memory 110 may be coupled to the integrated memory controller within processor 105 through memory interface 116. Examples of a memory interface include a double-data rate (DDR) memory interface, a dual-channel DDR memory interface, and a dynamic RAM (DRAM) memory interface.

In some implementations, processor 105 incorporates an integrated root complex in a PCIe interconnection hierarchy, with chipset 115 handling platform I/O functions. In modern systems, the memory controller and PCIe controller are integrated directly into processor 105, while chipset 115 manages I/O devices, in a similar manner as described below. In some embodiments, peer-to-peer routing is optionally supported through the root complex integrated within processor 105.

Here, chipset 115 is coupled to switch/bridge 120 through serial link 119. Input/output modules 117 and 121, which may also be referred to as interfaces/ports 117 and 121, include/implement a layered protocol stack to provide communication between chipset 115 and switch 120. In one embodiment, multiple devices are capable of being coupled to switch 120.

Switch/bridge 120 routes packets/messages (e.g., 150) on a link 123 from device 125 upstream, e.g., up a hierarchy towards the root complex, to chipset 115 and downstream, e.g., down a hierarchy away from the root complex, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, an NVMe/M.2 storage device, a CD/DVD ROM, a monitor, a printer, a mouse, a keyboard, a router, a portable storage device, a Universal Serial Bus (USB) device, a scanner, and other input/output devices. Often in the PCIe vernacular, such a device is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 (such as a graphics processing unit (GPU) or another hardware accelerator) may be also coupled to processor 105 through serial link 132. In one embodiment, graphics accelerator 130 communicates with processor 105 via integrated PCIe lanes, while I/O devices are coupled to chipset 115. I/O modules 131 and 118 are also implemented as a layered protocol stack to communicate between graphics accelerator 130 and processor 105. A graphics controller or the graphics accelerator 130 itself may be integrated within processor 105 as an integrated graphics processing unit (iGPU). It should be appreciated that one or more of the components (e.g., 105, 110, 115, 120, 125, 130) illustrated in FIG. 1 can be enhanced to execute, store, and/or embody logic to implement one or more of the features described herein.

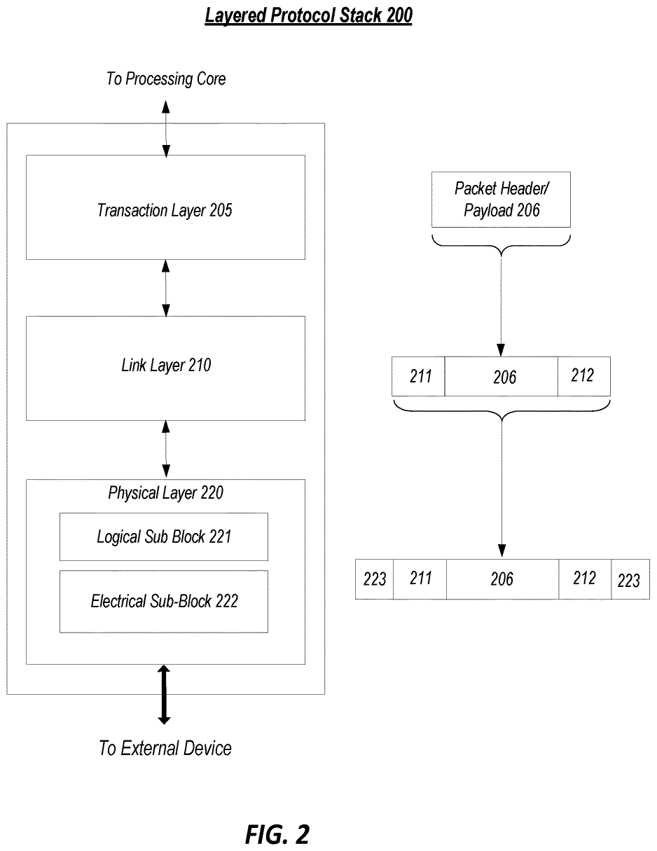

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

### Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (e.g., transaction layer packets, or TLPs). The translation layer 205 typically manages credit-based flow control for TLPs. PCIe implements split transactions, e.g., transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message transactions are defined to support in-band communication between PCIe agents.

Therefore, in one embodiment, transaction layer 205 assembles packet header/payload 156. Format for current packet headers/payloads may be found in the PCIe specification at the PCIe specification website.

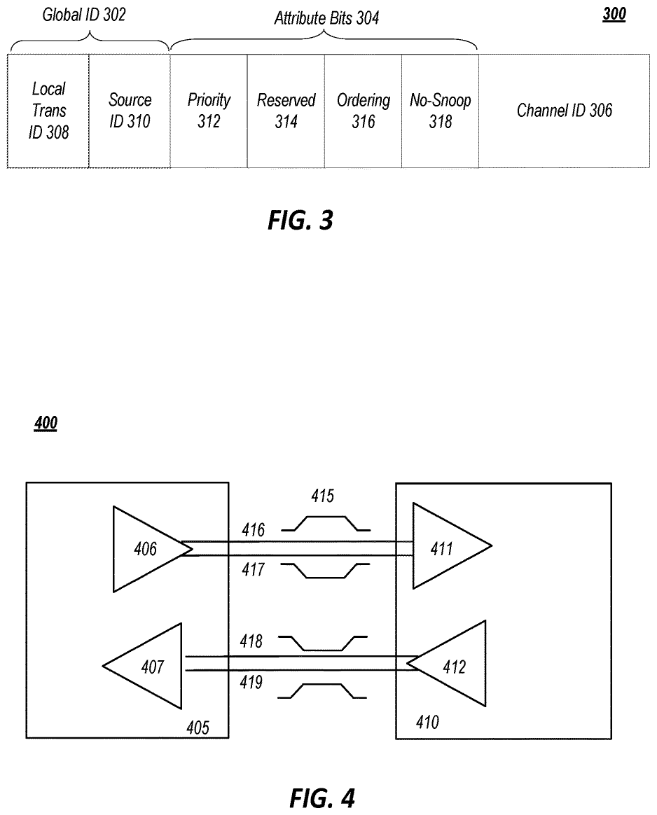

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

### Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, e.g., an identification number or packet number, calculates and applies an error detection code, e.g., CRC 212, and submits the modified TLPs to the Physical Layer 220 for transmission across a physical to an external device.

### Physical Layer

In one embodiment, physical layer 220 includes logical sub block 221 and electrical sub-block 222 to physically transmit a packet to an external device. Here, logical sub-block 221 is responsible for the “digital” functions of Physical Layer 220. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8b/10b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, e.g., a transaction layer; a second layer to sequence packets, e.g., a link layer; and a third layer to transmit the packets, e.g., a physical layer. As a specific example, a common standard interface (CSI) layered protocol is utilized.

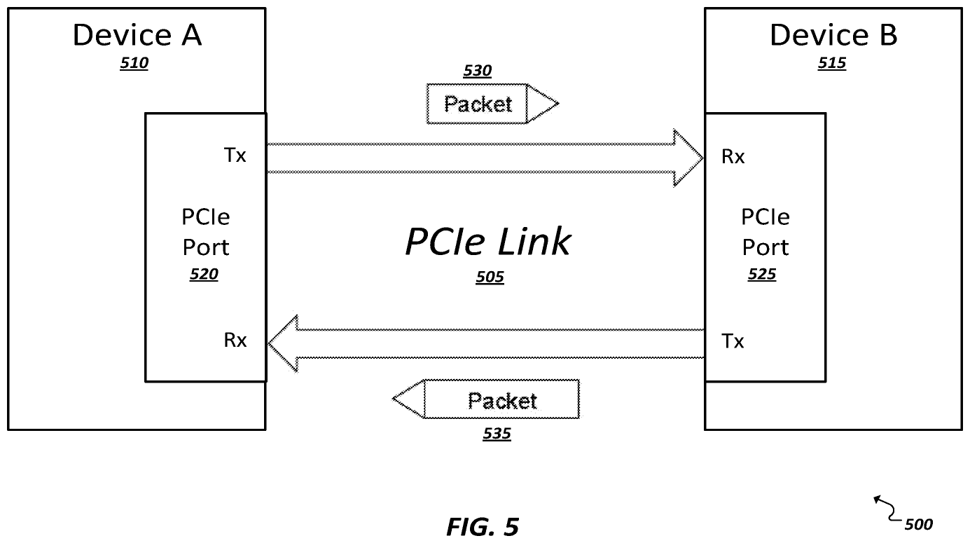

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, e.g., paths 416 and 417, and two receiving paths, e.g., paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where Nis any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., DisplayPort) may not and may even including only transmit or only receive pairs, among other examples.

A differential pair refers to two transmission paths, such as lines 416 and 417, to transmit differential signals. As an example, when line 416 toggles from a low voltage level to a high voltage level, e.g., a rising edge, line 417 drives from a high logic level to a low logic level, e.g., a falling edge. Differential signals potentially demonstrate better electrical characteristics, such as better signal integrity, e.g., cross-coupling, voltage overshoot/undershoot, ringing, etc. This allows for better timing window, which enables faster transmission frequencies.

In PCIe, rapid advancements are taking place as the protocol evolves from generation 4.0 to generations 5.0, 6.x, and 7.x. PCIe 4.0 may support 16 lane links with effective bandwidths of 64 GB/s and extended support for retimers and other features. PCIe 5.0 maintains the 16 lane link width, while doubling the effective bandwidth to 128 GB/s. To maintain these advances in bandwidth, PCIe 6.0 preserves the 16 lane link and adopts pulse amplitude modulation (PAM) encoding (e.g., PAM4 encoding), as opposed to PCIe's traditional non-return-to-zero (NRZ) encoding (e.g., 8b/10b, 128b/130b), to increase the number of bits that may be sent on a serial channel within a single unit interval (UI). Accordingly, PCIe 6.0 further doubles bandwidth to 64 GT/s from 32 GT/s in PCIe 5.0 thereby enabling 256 GB/s of bidirectional bandwidth. Such links may be valuably applied to couple devices such as a deep learning and artificial intelligence hardware accelerator devices; high speed graphic processor units, tensor processor units, and other deep learning processors; high-speed memory; and other hardware in a variety of emerging computing applications, from deep learning applications, autonomous vehicles, robotics, and high performance memory architectures, among other examples. PCIe 6.0 further includes low-latency Forward Error Correction (FEC) and other features to improve bandwidth efficiency, while maintaining backward compatibility with previous PCIe generations and similar channel reach to what is available in PCIe 5.0.

While high-speed PAM4 encoding allows links to realize new and improved applications, such links may be more susceptible to errors. In some implementations, a link and corresponding protocol may be configured to operate in multiple modes, such as a flit mode when high-speed PAM4 encoding is utilized and another (e.g., non-flit) mode when lower speed encoding (e.g., 8b/10b, 128b/130b NRZ) is used. For instance, a higher speed mode may utilize and particularly benefit from Forward Error Correction. Accordingly, a flit mode may be implemented, which subdivides the transmission of a single packet into a set of one or more defined flow control units, or “flits,” at the data link or logical PHY layer. However, such features may complicate parsing of the packet at the receiver. Each flit may include a respective header with information corresponding to the flit and packet, allowing some information traditionally reserved for the packet header to be omitted when redundant. In some implementations, two (or more) separate packet header formats may be defined for an interconnect (e.g., for PCIe 6.x- or 7.x-based interconnects), where a first packet header format is utilized for a mode utilizing flits for the packet transfer, and a different, second packet header format is utilized for a mode that does not utilize flits (e.g., a legacy mode defined in the protocol), among other example implementations. In some implementations it may be desirable to utilize flits for packet transfer when operating in lower speed modes (e.g., 8b/10b, 128b/130b NRZ).

In the case of PCIe, the transaction layer packet (TLP) header structure has evolved slowly but remained mostly unchanged. With the adoption of PAM4 encoding and a shift to flit-based data integrity with PCIe 6.0, a new, revised TLP header format may be utilized. The new, flit-mode TLP header may also address the reality that existing PCIe TLP headers lacks remaining reserved bits to expand the features and information, which may be communicated in corresponding packet header fields. In one example implementations, a flit-mode TLP header may replace the traditional, orthogonal, Format (Fmt) and Type fields to a fully-decoded 8-bit TLP Type field, which may be encoded with values to indicate all (or considerably all) existing TLP Types in PCIe, while adding new TLP types for no-op (NOP) and End Bad (EDB) packets types. Indeed, with flit mode, any number of NOP TLPs may be transmitted before or after any other TLP, with NOP TLPs discarded without effect by the receiver. Further the flit-mode TLP header may add new expanded header elements to include what had previously been communicated using TLP Prefixes and other mechanisms in PCIe, including Process Address Space Identifier (PASID), TLP Processing Hints, and Secure TLPs, among other examples. Other example modifications may include the addition of an 8-bit Segment ID (SBDF) to Requester and Completer ID, increasing the Tag field bits (e.g., 12, 14, or 16 bits), removing outdated fields and elements (e.g., the “Byte Count” field), among other example modifications.

Among the example benefits, which may be realized through a flit-mode packet header, the header may provide the ability for the receiver's transaction layer to robustly parse incoming TLP content without relying on TLP demarcation information from the Physical or Data Link Layers. As another example, extensibility of packets may be better facilitated via a flexible TLP structure consisting of a TLP Header Base followed by flexibly added additional header content (e.g., zero to 7 additional double words (DW) of content). In one example, the PCIe Transaction Digest may be replaced in flit mode packets by a “Trailer” of zero to 3 DW. In some implementations, the first DW of the Header Base includes all information requisite to determine the full size of the TLP, including the Header itself, any data payload, and the Trailer, if present. The End Bad (EDB) and Poisoned TLP mechanisms may also be modified, and in flit mode indicated via Suffixes which, if present, immediately follow the TLP to which they apply, and which, for Poisoned, are conveyed end-to-end with the TLP through Root Complexes that support peer-to-peer and all switches. Further, all TLP Type encodings defined for flit mode headers may be assigned flow control and routing for “forwards compatibility,” such that new opcodes can be allocated without requiring modification to existing switch and the generic blocks of PCIe controller hardware.

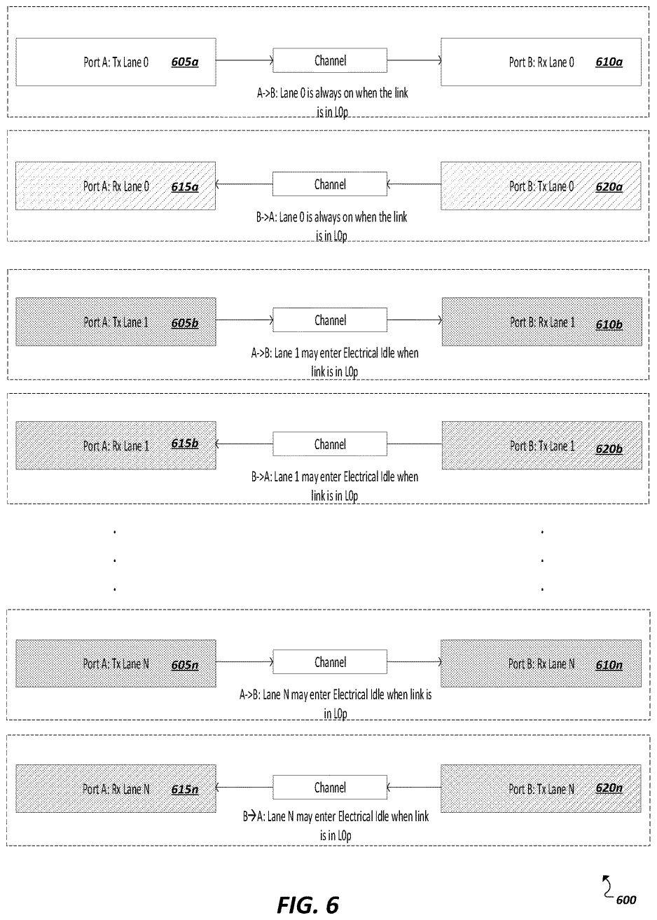

Turning to FIG. 5, a simplified block diagram 500 is shown illustrating an example PCIe link 505 coupling a first device 510 to a second device 515. Each of the devices 510, 515 may be equipped with one or more multiple ports (e.g., 520, 525) to support one or more multiple connections to other devices (e.g., on the same or different die or package). The port (e.g., 520, 525) may include transmit and receive circuitry as well as logic (e.g., implemented in hardware circuitry) to implement one or more interconnect protocols governing operation of a corresponding connection. For instance, ports 520, 525 may each include circuitry to implement a layered protocol stack of a PCIe-based protocol. The PCIe protocol (e.g., PCIe 6.0) may support both a flit mode and another non-flit mode. The corresponding protocol circuitry (e.g., of ports 520, 525) may be utilized to generate packets (e.g., 530, 535) with packet headers according to each of the flit mode and non-flit mode, such as discussed in the examples herein. Likewise, protocol logic at the devices 510, 515 (e.g., corresponding to the receivers of the ports 520, 525) may receive packets (e.g., 530, 535) generated and sent by another device and utilize information within the packets to identify boundaries of the packet and parse the packet and its contents (e.g., using fields such as discussed in the examples below).

In PCIe and other protocols, a “partial width” low-power state (e.g., L0p) may be defined and supported by the participating ports, where the number of active lanes can be dynamically adjusted to be less than or equal to the original configured width, for instance, in response to current bandwidth needs, while the remaining inactive lanes are in a power savings state. L0p entry refers to the process of reducing the number of active lanes, while L0p exit refers to the process of increasing the number of active lanes. Traditionally, the PCIe L0p scheme is symmetric, requiring the number of active lanes in each direction to be the same. For instance, during a traditional link width adjustment, when activating or deactivating a number of lanes in one direction, the same number of lanes are activated or deactivated in the other direction. In an improved implementation, the number of active Tx lanes may be independently controlled in each direction (or asymmetrically controlled). Logic resident on each of the link partner devices may be able to assess (e.g., reactively or predictively) its respective bandwidth usage, either autonomously through monitoring its internal queues, through information provided through registers programmed by software, utilizing machine learning or other techniques to predict its upcoming bandwidth usage, among other examples. Thus each link partner device has primary control of the number of its active Tx lanes. There are hooks that enable a device's link partner to dynamically and proactively provide input into how the device adjusts its Tx lanes to meet the link partner's receive bandwidth requirements, if any. Logic may be integrated into the ports to allow the flows for L0p entry and exit to be streamlined compared to the existing symmetric PCIe scheme, thus improving L0p entry and exit latencies. The independent control of link width per direction together with the smaller entry and exit latencies provide the ability to more quickly and more accurately adjust the link bandwidth characteristics to satisfy dynamic bandwidth needs of both asymmetric and symmetric workloads, while maximizing power savings, among other example benefits.

In some implementations, asymmetric partial width link states may be supported, such as asymmetric application of the PCIe L0s power savings state, which traditionally are to be applied simultaneously to all lanes in the link (e.g., no dynamic width adjustment, and has other restrictions (e.g., no SRIS mode, no retimers)). Due to limited power savings, L0s was defeatured in PCIe 6.0 (7.0) for Flit mode, when symmetric L0p was introduced. UXI 1.0 and UPI 3.0 define asymmetric L0p modes of operation, however, these schemes support only the link widths and link rates needed for UXI, only common clock mode, and no retimer support. Additionally, the UXI scheme only provides the ability for a device to control its Tx width, with no mechanism for influencing its Rx width, among other example shortcomings. An improved implementation provides a more flexible scheme that enables broader support of all PCIe clocking modes (e.g., common, SRNS, SRIS), all PCIe link widths, and PCIe link rates with 1b/1b encoding (e.g., 64 GT/s and greater), as well as retimers, and also provides additional hooks for a device to influence its Rx width, among other example features.

Asymmetric link width support may enable the link width in each direction of the link to be independently changed depending on the respective bandwidth demand and constraints in that direction. Such asymmetric link width adjustments may be carried out dynamically without stalling the link traffic. In one implementation, a set of messages are defined for managing asymmetric link width transitions (e.g., encoded in PCIe DLLPs) together with a set of protocol rules for managing interactions between the various message types and link width transitions and optimizing flows for entering and exiting L0p that minimize latency. Further, a special TS1 Ordered Set may be defined and utilized on activating lanes to mark known reference times, which can be used to determine skew between a reference lane (e.g., Lane 0) and each of the activating lanes and, additionally, to sync the Tx and Rx scrambler values on each of the activating lanes, among other example features. Compared to the existing PCIe symmetric L0p scheme, this approach provides the ability to more quickly and more accurately adjust link bandwidth characteristics to satisfy dynamic bandwidth needs of both asymmetric and symmetric workloads, while maximizing power savings. Since the proposed scheme is asymmetric, the two directions can have different widths depending on the dynamic bandwidth demand, optimizing power savings.

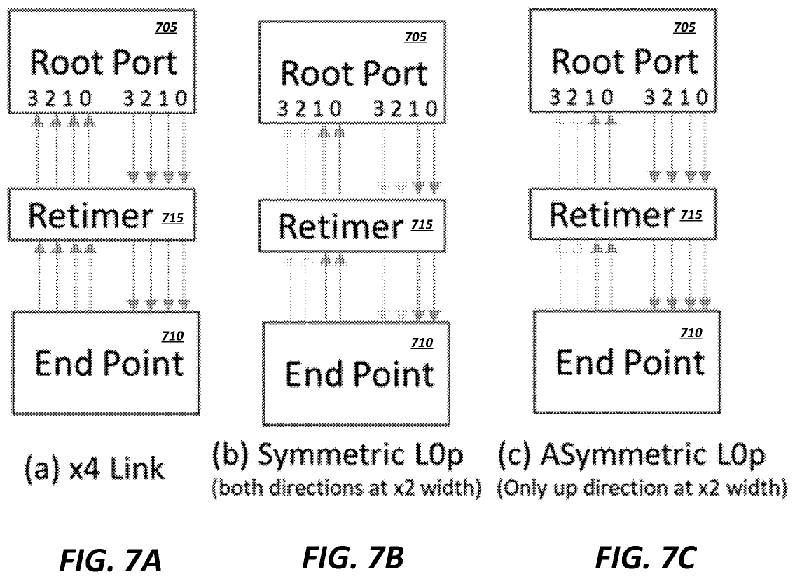

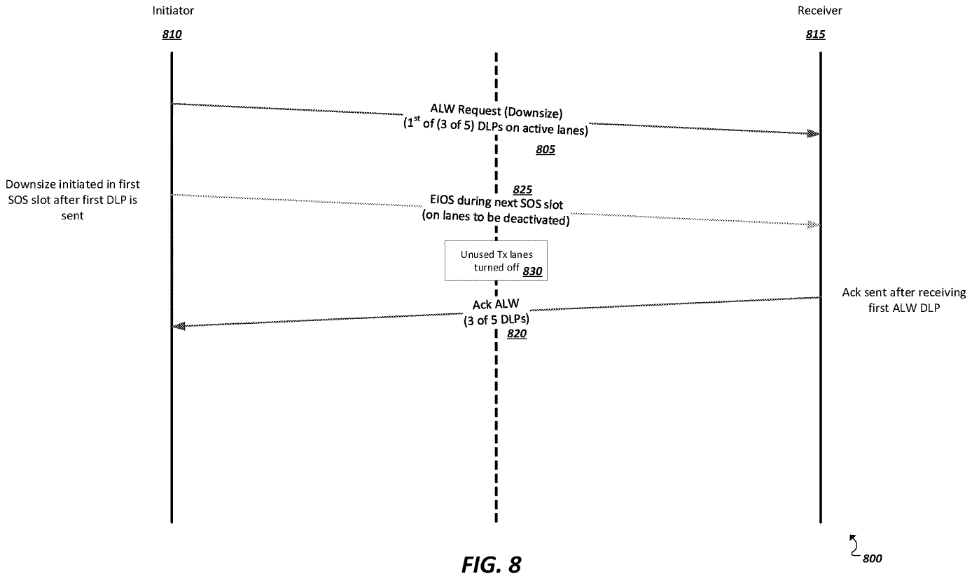

FIG. 6 is a simplified block diagram 600 showing an example bidirectional link with N lanes connecting Port A on one device to Port B on a second device. Port A's Tx lanes (e.g., 605a-n) are Port B's Rx lanes (e.g., 610a-n), and vice versa (e.g., Port A's Rx lanes 615a-n and Port B Tx lanes 620a-n). When a link is in a low power, partial link width L0p state (e.g., the existing symmetric or the proposed asymmetric), the number of active lanes is reduced, however, in this example, Lane 0 is to remain as one of the remaining active lanes. With symmetric L0p, both directions of a single lane are in the same power state. Asymmetric L0p, on the other hand, enables the number of active Tx lanes for Port A to be different from the number of active Tx lanes for Port B. FIGS. 7A-7C show an example involving a x4 Link coupling a root port 705 to an endpoint device 710 via a retimer 715 (as shown in FIG. 7A). The x4 link may be reducted to a partial width (e.g., in an L0p state). With the symmetric L0p (shown in FIG. 7B), both link directions are to have the same width (e.g., regardless of the actual bandwidth needs in each direction). Thus, the width goes to the maximum bandwidth demand on either side. With the asymmetric L0p, one can save additional power when either direction has comparatively lower bandwidth demand. For example, as shown in FIG. 7C, with asymmetric L0p, the up direction (e.g., from the endpoint device 710 to the root port 705) has a width of x2 whereas the down direction is x4 (the up bandwidth is less than half the peak bandwidth, but the peak bandwidth is maintained in the down direction). In that scenario, with symmetric L0p, both directions would be forced to remain at full width and not save any power since one direction needs the full bandwidth, among other examples.

Table 1 defines an example set of messages used for managing asymmetric link width transitions in one implementation. In this example, both link partner devices are to respectively and continually predict its transmit bandwidth needs and make Tx lane width adjustments using Asymmetric Link Width (ALW) requests. If a device anticipates an increase in its receive bandwidth requirements (e.g., it sent memory reads that will result in a large amount of completion responses on its receiver), it can issue a Minimum Link Width (MLW) request to communicate the minimum link width it requires on its receiver side to meet its bandwidth need, which would trigger its link partner to issue an ALW Request to upsize if its Transmitter's link width if it is lower than the advertised minimum bandwidth in the MLW request it received. As another example, if one of the link partner devices detects a performance issue, such as a thermal condition or has to reallocate power to some other entity temporarily, it can reduce power consumption by shrinking the allowable link width in both the transmit and the receive directions by using a High Priority Request (HPR). In some implementations, link width adjustment requests (e.g., an ALW or HPR) may have corresponding messages used to positively or negatively acknowledge the request (e.g., Ack HPR, Ack MLW, Nak MLW, Ack ALW, Nak, ALW). In some implementations, fewer (or even none) of these Ack and Nak responses may be supported or used. Indeed, while some of the examples show the use of Ack/Nak responses, it should be appreciated that such Ack/Nak responses may be omitted in other implementations. In some implementations, an ALW Upsize Request has an additional Complete Upsize handshake, whereas at least some of the other asymmetric partial link width requests may be satisfied with partial handshakes or unilateral requests or no ACKs at all, among other examples.

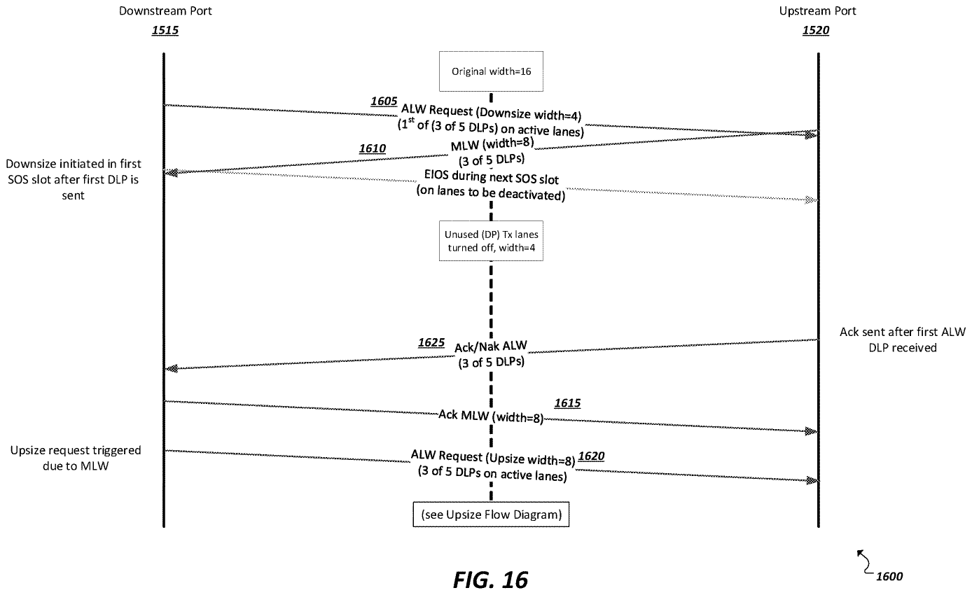

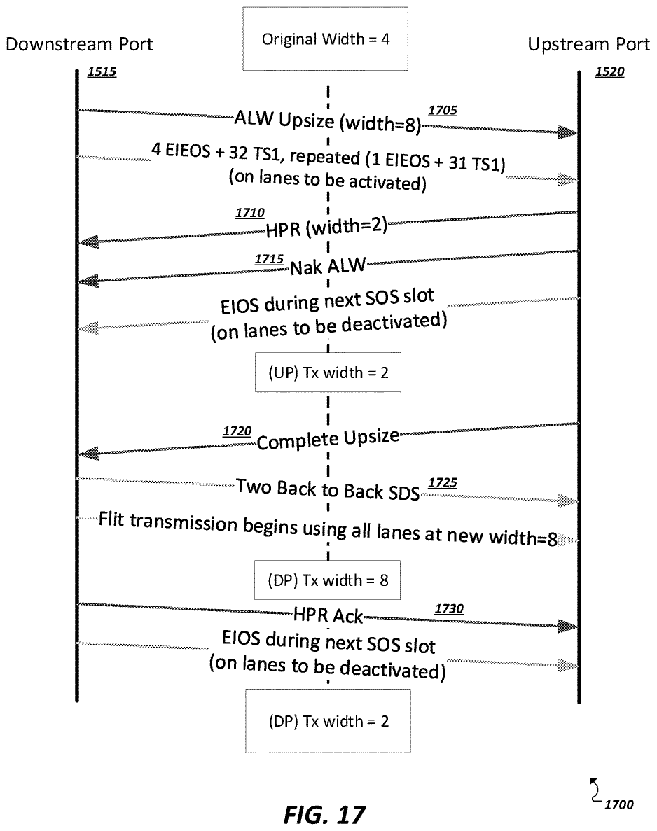

TABLE 1
Asymmetric L0p Messages

| Message Type | Description |
|---|---|
| HPR - High Priority Request | An HPR request takes precedence over all other |
| | request types. It is the only request type that has |
| | consequences in both directions. An HPR imposes a |
| | maximum link width, which is applicable to both |
| | directions. If both sides are requesting HPR, the lower |
| | of the two widths is the effective HPR width. If the |
| | current Tx link width is larger than the effective HPR |
| | width, then the Tx width will be reduced to the |
| | effective HPR width as part of the HPR request flow; if |
| | the current Tx link width is smaller than the effective |
| | HPR width, the Tx width remains at the current width. |
| | If the current Rx width is larger than the effective HPR |
| | width, then the link partner must reduce the Rx width |
| | to the effective HPR width as part of the HPR request |
| | flow; if the current Rx width is smaller than the |
| | effective HPR width, the Rx width remains at the |
| | current width. When an HPR is in effect, the link |
| | partner must not initiate upsize actions that increase |
| | the width to be greater than the effective HPR width. |
| | An HPR is typically used to manage thermal conditions |
| | and stays in effect until withdrawn. A few methods |
| | can be used to withdraw an HPR request by a Port: |
| | 1) Issuing an HPR request using the maximum |
| | configured link width in the Asymmetric L0p |
| | Request Width field withdraws a previous HPR |
| | but does not trigger an upsize. It just indicates |
| | that the thermal condition has resolved. |
| | 2) Issuing an ALW upsize request withdraws a |
| | previous HPR. |
| | 3) Issuing an HPR request with an L0p Request |
| | Width larger than the current link width but |
| | smaller than the maximum configured link |
| | width withdraws the previous HPR request |
| | while imposing the new maximum link width as |
| | the effective HPR width. Additionally, some |
| | implementations may choose to trigger an |
| | upsize action on the Tx lanes to the new |
| | effective HPR width unless the link partner also |
| | has an HPR request in effect at the current link |
| | width; however examples in this invention |
| | disclosure assume no upsize action. |
| | 4) Issuing an MLW with a target MLW width that |
| | is greater than the effective HPR width |
| | withdraws a previously issued HPR. |
| MLW - Minimum Link Width | An MLW request imposes a minimum link width a |
| | device expects on the receiver side (Rx direction) of its |
| | Port. When an MLW is in effect, the link partner is not |
| | permitted to send an ALW request with a target width |
| | that is lower than the MLW width in effect. An MLW |
| | remains in effect for 2 msec after the last Ack MLW is |
| | sent (unless its effect is terminated by a conflicting |
| | HPR, which takes precedence); the sender must send |
| | an MLW every 500 us−1 ms to continue the effect |
| | beyond the original 2 msec. A device must not send an |
| | MLW request if the HPR is in effect, and the effective |
| | HPR width is caused by the HPR request from the Link |
| | partner, |
| ALW - Asymmetric Link Width | An ALW request is used to initiate a link upsize or |
| Request | downsize request with the target width applied to the |
| | transmitter direction of the Port. |
| Complete Upsize | A Complete Upsize is sent by the receiver of an ALW |
| | request that has a target width greater than the |
| | current link width. This message indicates that the |
| | receiver is ready for its link partner's transmitter to |
| | merge the newly activated Lanes with the active Lanes |
| | by sending 2 SDS and transmitting traffic on the |
| | widened link. |
| Ack HPR | An Ack HPR must be sent in response to an HPR |
| | Request, within 1 us of receiving the request. |
| Ack MLW | An Ack MLW must be sent in response to an MLW |
| | Request, within 1 us of receiving the request, if a Nak |
| | MLW is not sent. The sender of the Ack MLW must |
| | honor the MLW for 2 msec after the last Ack MLW is |
| | sent, unless a thermal condition arises that causes an |
| | HPR to be sent by either device on the link. |
| Nak MLW | A Nak MLW must be sent in response to an MLW |
| | Request, within 1 us of receiving the request, if an HPR |
| | is in effect and the requested MLW width is greater |
| | than the maximum HPR width. |
| Ack ALW | An Ack ALW must be sent in response to an ALW |
| | Request, within 1 us of receiving the request, if a Nak |
| | ALW is not sent. |
| Nak ALW | A Nak ALW may be sent in response to an ALW Upsize |
| | Request if the width requested is greater than the |
| | maximum width of an HPR in effect. If the Nak does |
| | not abort the upsize; once the upsize completes, the |
| | receiver of the Nak must either initiate a new ALW |
| | Downsize request to the maximum HPR width in effect |
| | or complete a downsize as part of an HPR request flow |
| | already in progress. See also the example of FIG. 16. |
| | If the Nak aborts the upsize, then a subsequent |
| | Complete Upsize must not be sent. See also the |
| | example of FIG. 17. Whether a Nak aborts an upsize |
| | or not is predetermined based upon the agreed upon |
| | scheme implemented by both link partners. |

Similar to the mechanism for sending existing PCIe symmetric L0p messages, a single L0p message (or other link width adjustment message) may be defined to be sent in replicated, or consecutive packages, such by replicating and sending the L0p message in three out of five consecutive DLPs to ensure that at least one reaches the receiver. For instance, an example mapping of the messages into PCIe Link Management DLLPs is shown in Table 2. Byte 2 encodes asymmetric L0p requests and responses. Bytes 3 encodes the width associated with each request and response.

TABLE 2
Link Management DLLP: Asymmetric L0p Messages

| Field | Description (Link Management DLLP - Asymmetric L0p) |
|---|---|
| Byte 0 | Link Management DLLP - must be 0010 1000b |
| Byte 1 | Link Management DLLP - qualifies Bytes 2 and 3 |
| | 0000 0001b - Asymmetric L0p DLLP |
| Byte 2, | Asymmetric L0p Request (all encodings go with the Request |
| Bits [3:0] | Width) - each results in response, except when noted: |
| (for Asymmetric L0p) | 0000b: No request (width field is max configured width - ignored |
| | at receiver) |
| | 0001b: High Priority Request (HPR) |
| | 0010b: Minimum link width expected on the receiver side of Port |
| | (MLW) |
| | 0100b: Asymmetric Link Width Request (ALW) |
| | 0111b: Complete Upsize (Receiver: Send 2 SDS and merge the |
| | activated Lanes with the active Lanes) (Request Width field must |
| | match to the width the link partner's transmitter will be after |
| | upsizing) - no response for this request |
| | Others: Reserved |
| Byte 2, | Asymmetric L0p Response (all encodings go with a Response |
| Bits [7:4] | Width): |
| (for Asymmetric L0p) | 0000b: No response (width field is max configured width - ignored |
| | at receiver) |
| | 0001b: Ack HPR |
| | 0010b: Ack MLW |
| | 0011b: Nak MLW |
| | 0100b: Ack ALW |
| | 0101b: Nak ALW |
| | Others: Reserved |
| Byte 3, | Asymmetric L0p Request Width (behavior undefined if |
| Bits [3:0] | inconsistent-e.g., reserved value or link width > configured |
| (for Asymmetric L0p) | width): |
| | 0001b: x1 |
| | 0010b: x2 |
| | 0100b: x4 |
| | 1000b: x8 |
| | 0000b: x16 |
| | Others: Reserved |
| Byte 3, | Asymmetric L0p Response Width (must reflect the width of the |
| Bits [7:4] | request) |
| (for Asymmetric L0p) | Encodings are identical to those defined for Asymmetric L0p |
| | Request Width. |

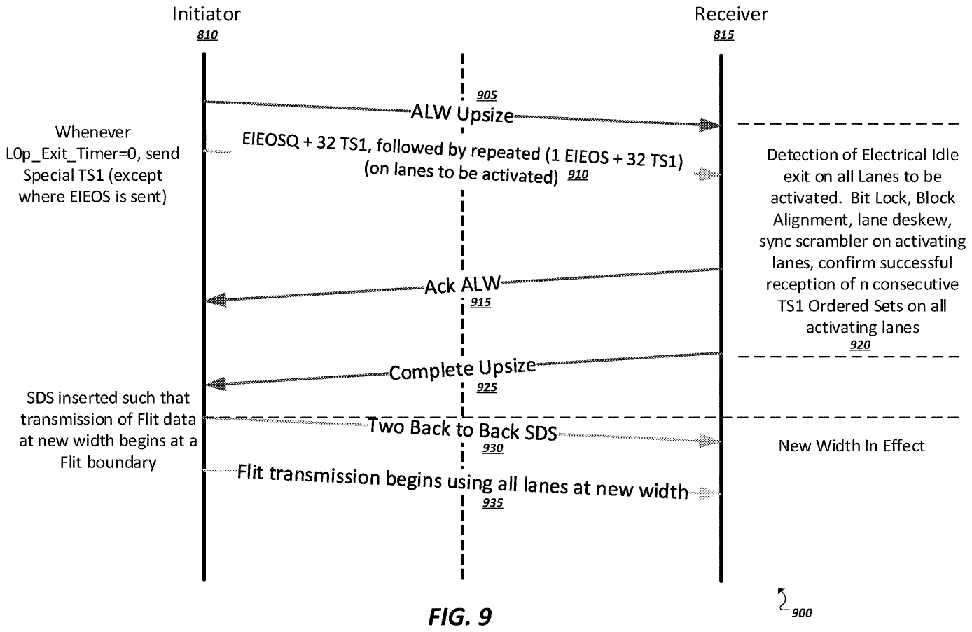

FIG. 8 is a signaling diagram 800 illustrating an example of a basic asymmetric L0p entry flow with an ALW request 805 for downsize, where the target Tx width is smaller than the current Tx width. The initiator 810 sends an ALW downsize request 805 on the active lanes by sending identical messages in three out of five consecutive DLPs. Upon receiving the request, the receiver 815 is to send an Ack or a Nak response (e.g., 820). Independent of waiting for the response, the initiator may complete the downsize action in the next SKP OS slot after the first DLP is sent and, on each lane to be deactivated, the initiator sends an EIOS (e.g., 825) in place of the SKP OS and then enters Electrical Idle to turn off (at 830) the lane in the Tx direction. Upon seeing the EIOS, the receiver transitions its Rx logic into a low power L0p state as well.

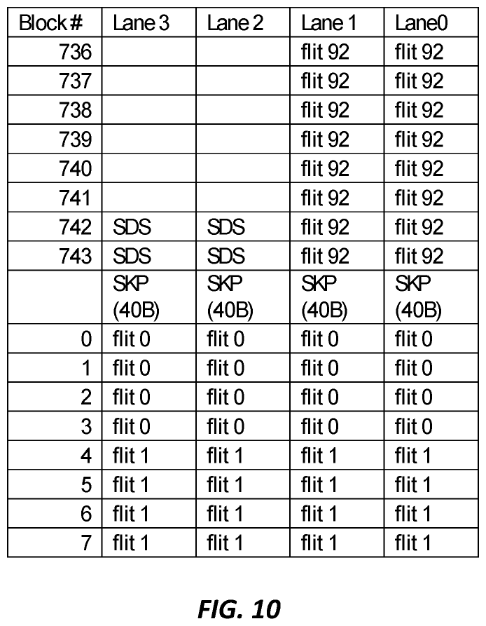

FIG. 9 is a signaling diagram 900 illustrating a basic L0p exit flow with an ALW request (e.g., 905) for upsize, where the target Tx width is larger than the current Tx width. In this example, a 16 ns L0p_Exit_Timer is to be implemented by the Initiator 810 and by the Receiver 815 on Lane 0. This timer is initialized prior to entering L0 in either the Configuration.Idle or Recovery. Idle LTSSM state. The L0p_Exit_Timer value adjusts after every block transmission at the initiator, by the appropriate value corresponding to the link rate (e.g., 0.5 ns every block at 256 GT/s, 1 ns every block at 128 GT/s rate or 2 ns every block at 64 GT/s rate); the timer does not move during CTRL SKP OS transmission. To initiate L0p exit, the initiator sends an ALW upsize request 905 on the active lanes. Simultaneously, on the lanes to be activated, the initiator sends (at 910) an EIEOSQ (e.g., per PCIe spec rules) and 32 TS1's followed by a repeated sequence of one EIOS and 32 TS1's. During transmission of this sequence 910, a special TS1 Ordered Set with a unique TS1 Identifier value (e.g., E4) is sent during any TS1 slots that correspond to L0p_Exit_Timer value of zero. The special TS1 Ordered Set markers are used by the Receiver to deskew the activating lanes relative to Lane 0 and to sync the scramblers (e.g., in lieu of waiting for and using a SKP OS). Upon receiving the ALW request 905, the receiver 815 sends an Ack or Nak response 915 (e.g., within 1 μs). The receiver detects (at 920) the Electrical Idle exit, obtains bit lock and block alignment, deskews the activating lanes relative to lane 0, and syncs the scrambler on all activating Lanes. Subsequently, after confirming successful reception of 8 consecutive TS1 Ordered Sets on all activating lanes, the receiver 815 sends a Complete Upsize handshake 925 indicating that the receiver is ready for the activating lanes to be merged with the active lanes to form the wider link. In some implementations, the unique TS1 identifier for the special TS1 Ordered Set is to be considered a match with the standard TS1 identifier when determining whether TS1 Ordered Sets are consecutive. After receiving the Complete Upsize handshake 925, the initiator 810 is to transmit two (e.g., and only two) back-to-back SDS Ordered Sets 930, aligned so that the second SDS on the activating lanes corresponds to the last block of transmission of a complete Flit on the active lanes. Immediately following the second SDS, the next Flit (at 935) is transmitted utilizing all the lanes of the newly widened link or, if required, a CTRL SKP OS is transmitted simultaneously on all the lanes of the newly widened link before transmitting the next Flit. The first CTRL SKP OS insertion after the SDS uses the OS insertion interval associated with the old link width and subsequent CTRL SKP OS insertions use the OS insertion interval associated with the new link width. The OS insertion interval is an integer flit count as specified in the PCIe specification.

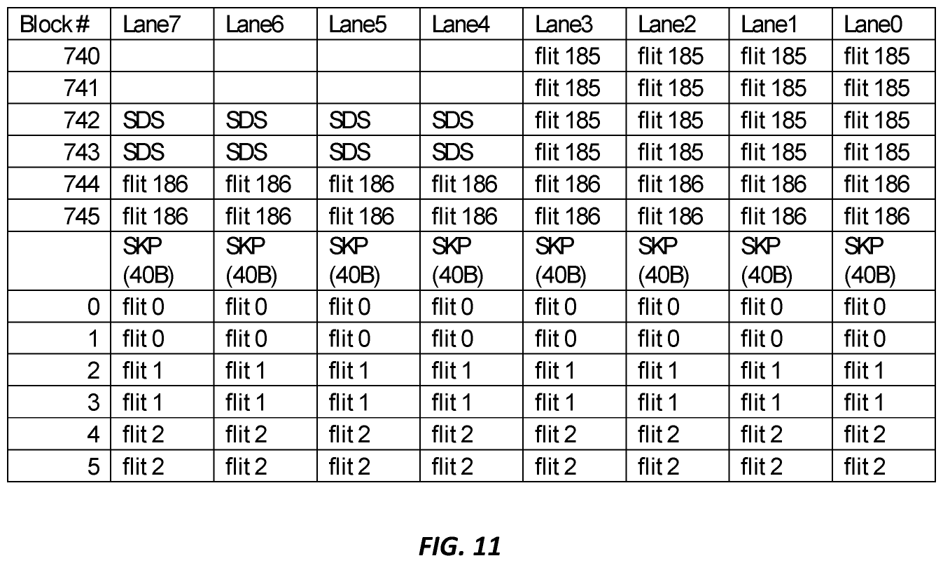

FIG. 10 illustrates an example of a link upsize signaling sequence where an SDS sequence is inserted immediately before a CTRL SKP OS slot (e.g., with SRNS/common clocking topology). With 93 flits (Flit 0 thru Flit 92) transmitted since the last CTRL SKP OS insertion on a x2 link, the PCIe specification requires the next transmission to be a CTRL SKP OS. The SDS sequence on the activating lanes aligns with the last two blocks of Flit 92 transmission on the active lanes. Immediately after the required CTRL SKP OS, the new Flit 0 is transmitted using all lanes of the newly widened x4 link.

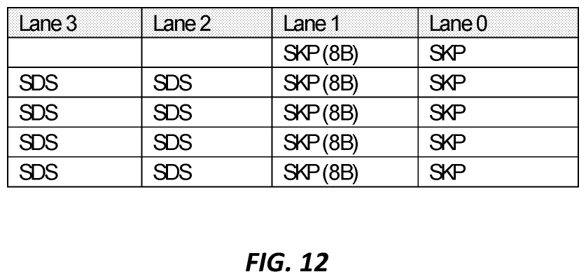

FIG. 11 illustrates another example of a link upsize signaling sequence where the SDS sequence is inserted before reaching the flit count for inserting a CTRL SKP OS. With 187 flits specified by the PCIe specification as the Ordered Set insertion interval for a x4 link, the SDS sequence aligns with the last two blocks of the 186th Flit (Flit 185), which means that one more Flit is to be transmitted before a CTRL SKP OS is inserted. Immediately following the second SDS, Flit 186 is transmitted using all lanes of the newly widened x8 link. Subsequently, with 187 flits transferred since the last CTRL SKP OS, a CTRL SKP OS must be transmitted. Future CTRL SKP OS insertions follow the OS insertion interval for a x8 link, which is after every 374 flits. In this example, some implementations may find instead insert the first CTRL SKP OS after block 747, which would correspond to after 187 flits are transmitted with the old x4 link width. This allows more time for the logic associated with a lane to recalculate when the next CTRL SKP OS must be inserted. For instance, when inserting a CTRL SKP OS, it can determine when the subsequent one must be inserted without monitoring for link width changes in between, among other example features.

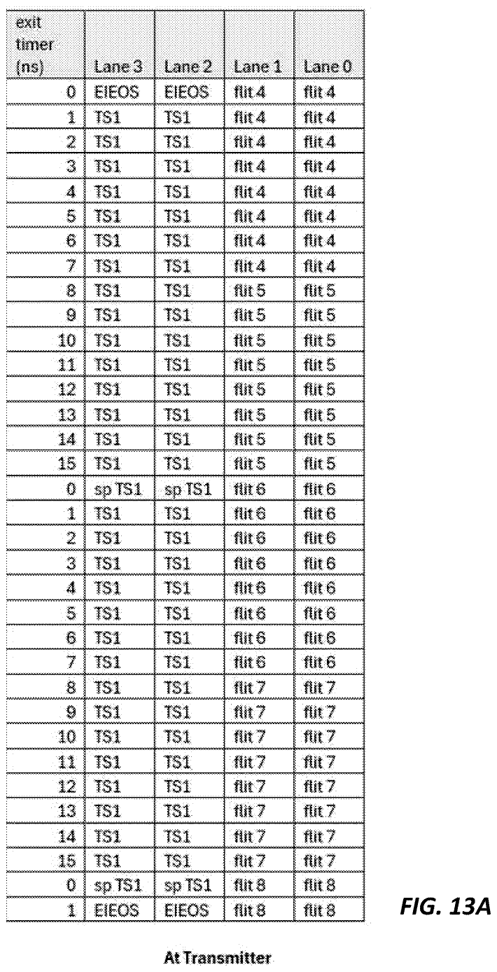

During link upsizing, scenarios where any of the SDS symbols on the activating lanes coincide with any of the CTRL SKP OS symbols on the active lanes may not be permitted so as to avoid situations where a retimer removes SKP symbols on the active lanes while merging the activating lanes with the active lanes. FIG. 12 shows one example of an illegal SDS insertion scenario (e.g., where each line represents 8 bytes of transmission). For instance, if any SKP symbols were added or removed by a retimer, that would cause alignment problems for the flit transmitted immediately after the SDS. During link upsizing, if the initiator injects a CTRL SKP OS on the active lanes, it should simultaneously inject a CTRL SKP OS on each of the activating lanes. If a retimer adds or deletes SKP symbols on the active lanes, it is to also add or delete the exact same number of SKP symbols on each of the activating lanes. With the above two constraints, the receiver is to perform lane-to-lane deskew once during the link upsize process.

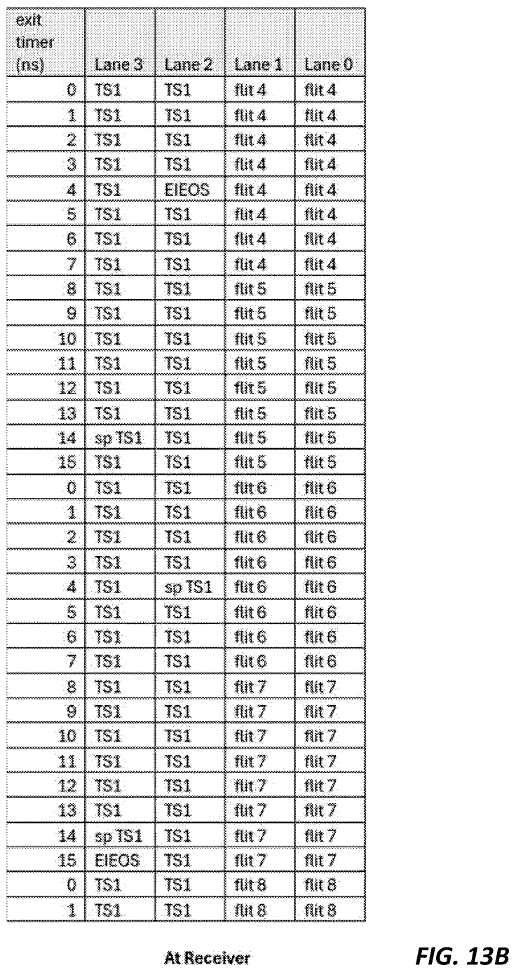

FIGS. 13A-13B shows an example of lane skew correction. FIG. 13A shows the signaling from the side of the transmitter and FIG. 13B shows the signaling from the side of the receiver, where lane-to-lane deskew is to be corrected during L0p exit. Note, the diagram shows the data at the receiver after it has already completed block alignment. As mentioned earlier, when entering the data stream from Configuration.Idle or Recovery.Idle, the L0p_Exit_Timer is initialized so that the first data block transmitted after the SDS sequence on Lane 0 corresponds to a timer value of 0. The L0p_Exit Timer value adjusts after every block transmission, by the appropriate value corresponding to the link rate (e.g. 0.5 ns every block at 256 GT/s, 1 ns every block at 128 GT/s rate or 2 ns every block at 64 GT/s rate); the timer does not move during CTRL SKP OS transmission. The receiver similarly maintains an L0p_Exit_Timer based on what it receives on Lane 0. During L0p upsizing, the transmitter sends special TS1 Ordered Sets (denoted as sp TS1 in FIG. 7) in place of any scheduled TS1 ordered sets in slots that correspond to an L0p_Exit_Timer value of zero. During upsizing, the receiver determines skew between lanes by comparing when the special TS1 Ordered Sets are received relative to when the L0p_Exit_Timer value is 0 on Lane 0. Since the PCIe specification limits lane-to-lane skew at the receiver for link rates that utilize 1b/1b to 5 ns, the receiver should receive any special TS1 Ordered Sets on the activating lanes offset by no more than 5 ns from a block on Lane 0 corresponding to L0p_Exit_Timer value=0. This means that with a 16 ns timer, the activating lanes should be adjusted to align any special TS1 Ordered Set with the nearest block on Lane 0 corresponding to L0p_Exit_Timer value=0. In this example, Lane 2 and Lane 3 are the activating lanes. By examining when the special TS1 Ordered Sets are received, the receiver can determine that Lane 2 is delayed by 4 ns relative to Lane 0 and that Lane 0 is delayed by 2 ns relative to Lane 3.

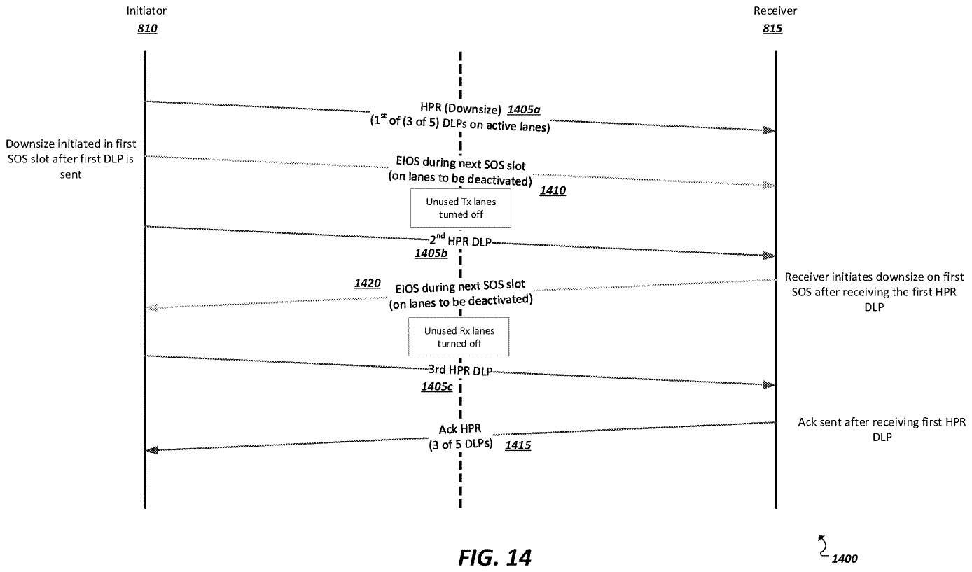

FIG. 14 is a signaling diagram 1400 illustrating an example basic HPR flow. The initiator 810 sends an HPR downsize request on the active lanes to the receiver 815 by sending identical messages (e.g., 1405a-c) in three out of five consecutive DLPs. Independent of waiting for the response, the initiator 810 completes the downsize action in the next SKP OS slot after the first DLP is sent. For each Tx lane to be deactivated, the initiator sends an EIOS 1410 in place of the SKP OS and then enters Electrical Idle to turn off the lane in the Tx direction. Upon seeing the EIOS, the receiver transitions its Rx logic into a low power state. Upon receiving the HPR request, the receiver is to send an Ack response (e.g., 1415) (in some implementations a Nak is not permitted) and is to also initiate a downsize action by scheduling an EIOS (e.g., 1420) in place of the next SKP OS slot on each of its transmit lanes to be deactivated before entering Electrical Idle on those lanes (note: these are labeled as Rx lanes in the diagram as they correspond to Rx lanes of the initiator). Upon seeing the EIOS 1420, the initiator 810 transitions its Rx logic into a low power state. The HPR remains in effect until it is withdrawn by the original initiator (e.g., 810).

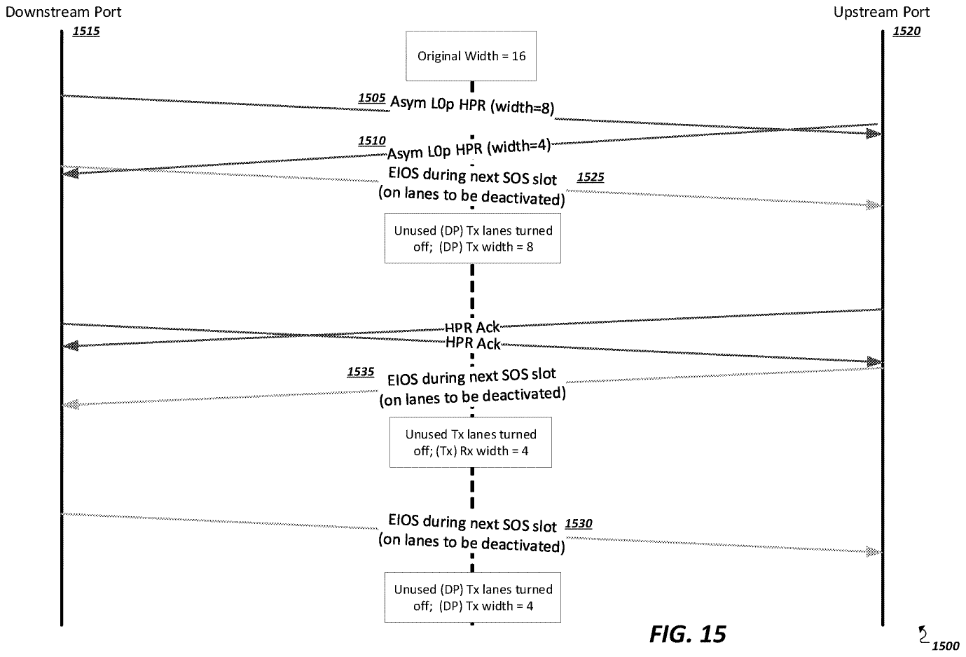

FIG. 15 is a signaling diagram 1500 showing an example of simultaneous HPR requests (e.g., 1505, 1510) from a Downstream Port 1515 and from an Upstream Port 1520 that cross each other on the link. In this example, the Downstream Port 1515 transmits an HPR downsize request 1505 to a link width of 8 and transmits an EIOS 1525 to complete the downsize action to width=8 just before receiving an HPR request 1510 with link width=4 from the Upstream Port 1520. The Downstream Port 1515 subsequently completes another downsize action on its transmitter lanes at the next scheduled SKP OS slot by transmitting an EIOS 1530 and reducing its Tx width to 4. In the meantime, the Upstream Port transmits an HPR downsize request (e.g., 1510) to a link width of 4 and immediately receives an HPR downsize request (e.g., 1505) to a link width of 8 from its link partner. In some implementations, in the case of conflicting concurrent link width adjustment requests (e.g., 1505, 1510), the lower width takes precedence. As such, in the example of FIG. 15, the Upstream Port 1520 transmits an EIOS 1535 and completes a single downsize action to width=4. Note that if the Downstream Port 1515 had received the HPR request 1510 to width=4 from its link partner before it completed its first downsize action, it could have completed a single downsize action directly to the lower width=4 instead of going through two downsize actions, to width=8 and then to width=4.

FIG. 16 is a signaling diagram 1600 showing an example of an ALW downsize request 1605 from the Downstream Port 1515 and an MLW request 1610 from the Upstream Port 1520 issued simultaneously such that they cross each other on the link. Immediately after the Downstream Port 1515 completes the downsize action on its Tx lanes to link width=4, it receives an MLW 1610 from its link partner 1520 with minimum link width of 8. The Downstream Port 1515 sends an Ack MLW 1615 and then, due to the MLW 1610, issues an ALW upsize request 1620 to width=8. In the meantime, immediately after issuing an MLW 1610, the Upstream Port receives an ALW downsize request 1605 to a width lower than minimum link width that it had just requested. The Downstream Port can choose to Ack or Nak (at 1625) the ALW as that does not alter the outcome in this case.

FIG. 17 is a signaling diagram 1700 showing an example of an ALW Upsize Request 1705 from a Downstream Port 1515 simultaneous with an HPR downsize request 1710 from an Upstream Port 1520. In this particular example, the original width is x4 in both directions. The Downstream Port 1515 requests an ALW Upsize 1705 of its Tx lanes to a width of 8 and immediately begins the upsize action. In the middle of the upsize flow, the Downstream Port 1515 receives an HPR downsize request 1710 to a width of x2, and it also receives a Nak ALW 1715 in response to its ALW Upsize Request 1705. In a scheme where ALW Upsize flows are not aborted, the Downstream Port 1515 still waits for the Complete Upsize Handshake 1720 and then completes the upsize action to grow its Tx lane width to 8, by sending the SDS Sequence 1725 and merging the 4 activating lanes with the original 4 lanes. Next, the Downstream Port sends an Ack HPR 1730 in response to the HPR 1710 it had received earlier and sends an EIOS in the next SKP OS slot to complete the downsize action of its Tx lanes to a width of 2. The Downstream Port 1515 is to complete the upsize action for the ALW Request 1705 it sent before it completes the downsize action for the received HPR 1710, otherwise, the link will end up at the incorrect width. In the meantime, after sending an HPR downsize request 1710, the Upstream Port 1520 sends a Nak ALW 1715 in response to the ALW Upsize 1705 before completing the downsize action of its Tx lanes, however, the Upstream Port 1520 continues to participate in the flow to enable its link partner 1515 to complete its upsize action with the understanding that a downsize action will follow afterwards.

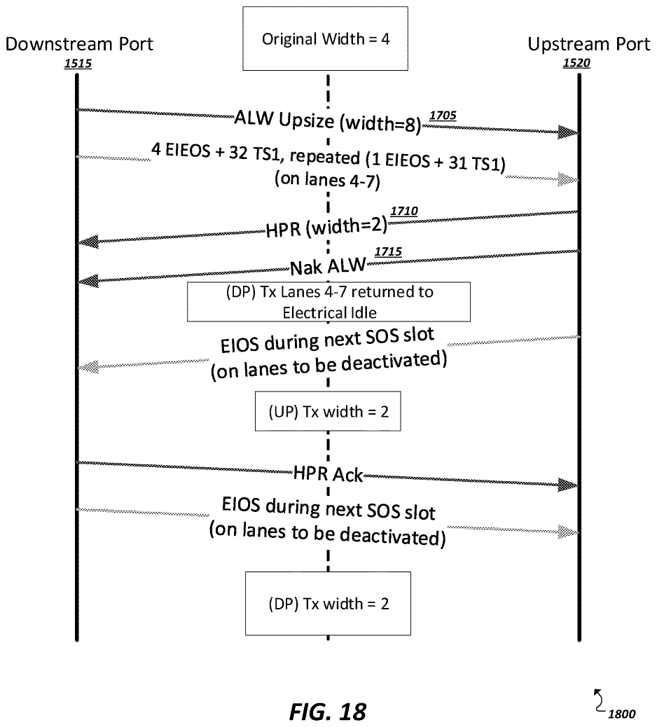

Not supporting aborts results in a slightly inefficient flow, such as shown in the example signaling diagram 1700 shown in FIG. 17, as the Downstream Port's Tx lanes are to temporarily transition to the higher width before transitioning to the lower width. Allowing aborts of upsize flows enables a slightly more efficient flow, such as shown in the signaling diagram 1800 of the example of FIG. 18. For instance, if the Upstream Port 1520 had already responded with an Ack ALW before sending the HPR in FIG. 17, it should enable the Downstream Port to complete the upsize action.

FIG. 18 shows an example of an ALW Upsize Request 1705 from the Downstream Port 1515 that is aborted due to an HPR Downsize Request 1710 from the Upstream Port 1520. Upon seeing the Nak ALW 1715, the Downstream Port 1515 returns the lanes it was in the process of activating back to Electrical Idle state. The Downstream Port 1515 stops waiting for the Complete Upsize handshake and instead proceeds directly with downsizing its Tx lanes to satisfy the HPR Request 1710. Similarly, because the Upstream Port sent a Nak ALW 1715, it should not send a Complete Upsize handshake and instead transitions its receiver logic on lanes 4-7 back to a low power state. The Upstream Port completes the downsize of its Tx lanes and waits for its Rx lanes to be downsized.

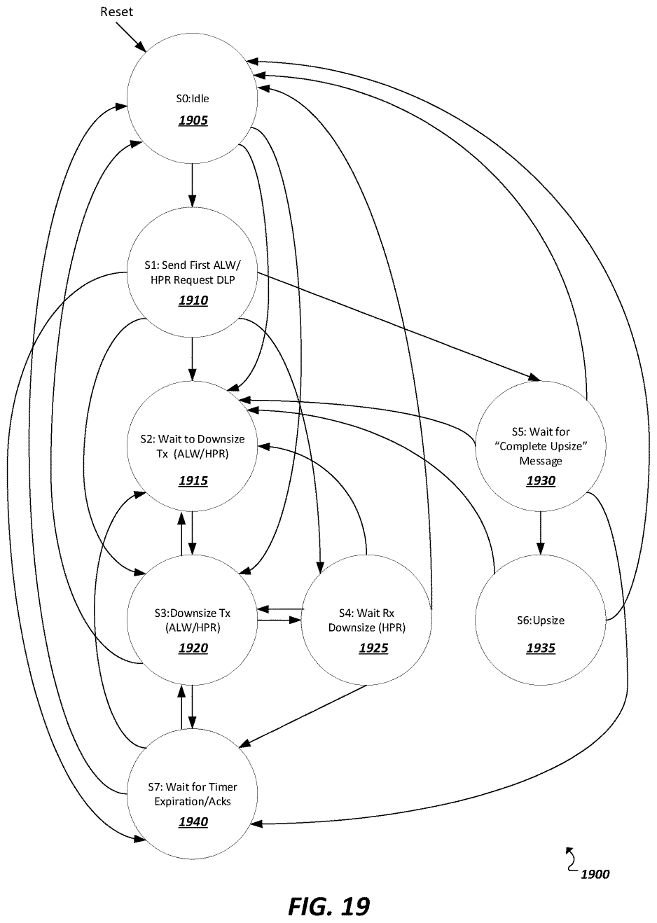

FIG. 19 is a diagram 1900 illustrating an example of a potential state machine implementation for managing asymmetric L0p upsize and downsize flows. This state machine implementation assumes that the link partner can send an HPR request at any time and also assumes that ALW upsize requests are aborted due to receiving a Nak ALW prior to receiving a Complete Upsize. MLW requests are issued independently and not tracked in this state machine. The states implemented are as follows:
S0: Idle (1905)—No pending ALW or HPR requests.
S1: Send First ALW/HPR Request DLP (1910)—The first DLP of the ALW or HPR Request is sent in this state. This is an optional state. If this state is eliminated, the first ALW or HPR downsize request DLP is sent during transition from S0 to S1 and the first ALW upsize request is sent during transition from S0 to S5.
S2: Wait to Downsize Tx (1915)—This state is used to wait until the next scheduled Ctrl SKP OS slot to downsize the Tx lanes.
S3: Downsize Tx (ALW/HPR) (1920)—An EIOS is transmitted in place of the scheduled Ctrl SKP OS on each of the lanes being deactivated. If an HPR was received from the link partner with a smaller target link width than that associated with the request issued from this Port, transition directly to the smaller link width. This is an optional state. If this state is eliminated, the EIOS is transmitted during transition from S2 to S7 or during the transition from S2 to S4.
S4: Wait Rx Downsize (HPR) (1925)—This state is used to wait for the link partner to complete downsize for an HPR Request sent from this port. This state is NOT used for HPR Requests received from the link partner.
S5: Wait for “Complete Upsize” Message (1930)—This state is used to wait for the link partner to complete bit lock and block alignment, to deskew the lane, to sync its Rx descrambler value, and to successfully receive 8 consecutive TS1 Ordered Sets for each activating lane. A timeout is recommended to transition to state S6 if a previous Ack HPR was received.
S6: Upsize (1935)—This state is used to insert 2 back-to-back SDS Ordered Sets on each activating lane to merge the activating lanes with the active lanes. The SDS Sequence insertion must be aligned so that the second SDS on the activating lanes corresponds to the last block of transmission of a complete Flit on the active lanes. There may be some wait time in this state to wait for the correct alignment.
S7: Wait for Timer Expiration/Acks (1940)—This state is used to ensure that a response intended for the previous HPR or ALW request does not return after a new request has been sent. All three request DLPs (out of 5 consecutive DLPs) must have been sent and that all three Ack or Nak response DLPs (out of 5 consecutive DLPs) must have been received before sending a new ALW or HPR Request. A timer must be implemented to track the time since the first request DLP was transmitted; once that timer reaches a timeout threshold (recommended to be twice the (time corresponding to 5 Flits plus lus) but other values are possible), a new independent request is permitted to be issued.

The conditions for transitioning between states are as follows:
Arc_AnyState_to_S0: A Reset or Recovery returns the state machine to the S0 state.
Arc_S0_to_S1:
   An upsize is desired and, if an HPR is in effect from the link partner, the target width is less than or equal to effective HPR width or
   A non-priority downsize is desired and, if an MLW is in effect from the link partner, the target width is greater than or equal to effective MLW width or
   A priority downsize is desired or
   A withdrawal of a previously issued HPR is desired or
   An increase in the effective HPR width is desired.
Arc S0 to S2: This transition happens if an HPR Request is received from the link partner where the target HPR width is less than the current Tx width and a Ctrl SKP OS is not scheduled to be issued in the next cycle.
Arc_S0_to_S3: This transition happens if an HPR Request is received from the link partner where the target HPR width is less than the current Tx width and a Ctrl SKP OS is scheduled to be issued in the next cycle.
Arc_S1_to_S2: The transition happens immediately after a Flit that carries the first DLP for an ALW Downsize or HPR Downsize Request has finished transmitting if a Ctrl SKP OS is not scheduled to be transmitted next.
Arc S1_to_S3: The transition happens immediately after a Flit that carries the first DLP for an ALW Downsize or HPR Downsize Request has finished transmitting if a Ctrl SKP OS is scheduled to be transmitted next.
Arc_S1_to_S4: The transition happens immediately after a Flit that carries the first DLP for an HPR Downsize Request has finished transmitting if the current Tx width is already less than or equal to the target HPR width of a transmitted or received HPR request, but the current Rx width is greater than the target HPR width for an HPR request transmitted from this Port.
Arc_S1_to_S7: This transition happens immediately after a Flit that carries the first DLP for an HPR Request that does not require a downsize action, e.g., either an HPR withdrawal or an HPR request with a target width greater than both the current Tx width and the current Rx width, has finished transmitting.
Arc_S1_to_S5: This transition happens immediately after a Flit that carries the first DLP for an ALW Upsize Request has finished transmitting.
Arc_S2_to_S3: The transition happens if a Ctrl SKP OS is scheduled to begin transmitting in the next clock cycle.
0 Arc S3 to S4: After transmitting the EIOS on the deactivating lanes and transitioning those Tx lanes to Electrical Idle, if the current Rx width is greater than the target HPR width for an HPR Request issued from this Port, then transition to S4.
Arc_S3_to_S2: This arc is required because the link partner is permitted to send an HPR request at any time. After transmitting EIOS on lanes to be deactivated and transitioning those lanes to Electrical Idle, if the current Tx width is greater than the effective HPR width for an HPR issued from the link partner, then transition to S2 to wait for the next scheduled Ctrl SKP OS slot.
Arc S3 to S0: After transmitting the EIOS on the deactivating lanes and transitioning those Tx lanes to Electrical Idle, if any one of the following is true, then transition to S0:
   If an HPR Request was sent, the current Rx width is not greater than the target HPR width for an HPR Request sent from this port and either all three Ack HPR DLPs have been received or the timer tracking the time since the first HPR or ALW Request DLP was transmitted has reached its timeout threshold.
   If an ALW Request was sent, all three Ack ALWs or Nak ALWs have been received or the timer tracking the time since the first HPR or ALW Request DLP was transmitted has reached its timeout threshold.
   No HPR Request or ALW Request was sent, e.g., transition into this state was due to an HPR Request received from the link Partner.
Arc_S3_to_S7: After transmitting the EIOS on the deactivating lanes and transitioning those Tx lanes to Electrical Idle, if the current Rx width is not greater than the target HPR width for an HPR Request issued from this Port or if an HPR Request was not issued and the following is also true, then transition to S7:
   If an HPR Request was sent, not all three Ack HPR DLPs have been received and the timer tracking the time since the first HPR Request DLP was transmitted has not reached its timeout threshold.
   If an ALW Request was sent, not all three Ack or Nak ALWs have been received and the timer tracking the time since the first ALW Request DLP was transmitted has not reached its timeout threshold.
   If no HPR Request or ALW Request was sent, e.g., transition into this state was due to an HPR Request received from the link Partner, then no additional requirement must be met.
Arc S4 to_S2: This arc is required because the link partner is permitted to send an HPR request at any time. After receiving an EIOS each of the deactivating Rx lanes and transitioning the relevant Rx lanes to low power state, if the current Tx width is greater than the effective HPR width for an HPR issued from the link partner, then transition to S2 to wait for the next scheduled Ctrl SKP OS slot, unless the Ctrl SKP OS slot is scheduled the next cycle.
Arc S4 to S3: This arc is taken instead of Arc_S4_to_Ω if all the conditions for Arc S4 to S2 are met, except a Ctrl SKP OS is scheduled the next cycle.
Arc S4 to S0: After transitioning relevant Rx lanes to low power state, transition to S0 if all three Ack DLPs have been received for the issued HPR Request or if the timer tracking the time since the first HPR Request DLP was transmitted has reached its timeout threshold.
Arc_S4_to_S7: After transitioning relevant Rx lanes to low power state, transition to S7 if not all three Ack DLPs have been received and if the timer tracking the time since the first HPR Request DLP was transmitted has not reached its timeout threshold.
Arc S5_to_S6: This transition is triggered when a Complete Upsize Handshake is received.
Arc S5_to_S2: This transition is triggered if a Nak ALW was received and an HPR Request was received from the link partner where the target HPR width is smaller than the current Tx link width.
Arc_S5_to_S0: This transition is triggered if a Nak ALW was received and no HPR Request was received from the link partner where the target HPR width is smaller than the current Tx link width and either all three Nak ALW DLPs have been received or the timer tracking the time since the first ALW Request DLP was transmitted has reached its timeout threshold.
Arc_S5_to_S7: This transition is triggered if a Nak ALW was received and no HPR Request was received from the link partner where the target HPR width is smaller than the current Tx link width and not all three Nak ALW DLPs have been received and the timer tracking the time since the first ALW Request DLP was transmitted has not reached its timeout threshold.
Arc_S6_to_S0: If two back-to-back SDS Ordered Sets have been transmitted on each of the activating lanes and at least one Flit has been transmitted on the newly widened link and if all three “Complete Upsize” DLPs have been received (or four Flits have been received since receiving the first “Complete Upsize” DLP), then transition to S0.
Arc S6 to S2: After two back-to-back SDS Ordered Sets have been transmitted on each of the activating lanes and at least one Flit has been transmitted on the newly widened link, transition to S2 if an HPR request was received from the link partner where the target HPR width is smaller than the current Tx link width.
Arc_S7_to_S0: This transition is triggered if any of the following conditions are met:
   If an HPR Request was sent, all three Ack HPR DLPs have been received.
   If an ALW Request was sent, all three Ack ALWs or Nak ALWs have been received.
   The timer tracking the time since the first HPR or ALW Request DLP was transmitted has reached its timeout threshold.
Arc S7_to_S2: This arc is required because the link partner is permitted to send an HPR request at any time. If an HPR request is received from the link partner and the current TX width is greater than the target HPR width of the received HPR request, then transition to S2 to wait to downsize the Tx lanes unless a Ctrl SKP OS is scheduled to be sent the next cycle.
Arc_S7_to_S3: This arc is required because the link partner is permitted to send an HPR request at any time. If an HPR request is received from the link partner and the current TX width is greater than the target HPR width of the received HPR request, then transition to S3 to downsize the Tx lanes if a Ctrl SKP OS is scheduled to be sent the next cycle.

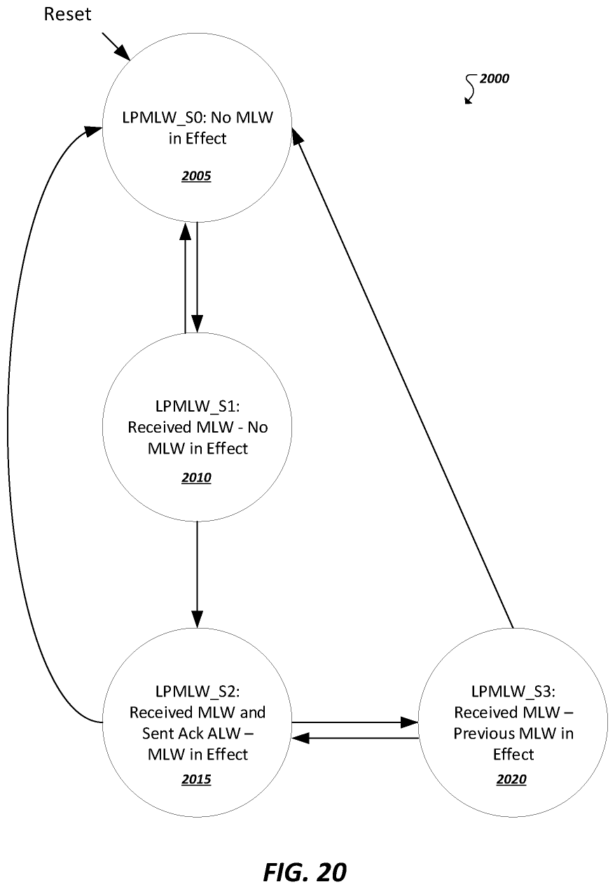

FIG. 20 is a diagram 2000 showing an example of a potential state machine to track MLWs received from the link partner. In this example, the states implemented include:
LPMLW S0 (2005)—No MLW is in effect from the link partner.
LPMLW_S1 (2010)—An MLW was received from the link partner.
   If no HPR is in effect from the local Port or if the target MLW width is less than or equal to the HPR width in effect from the local Port, then schedule an Ack MLW and save off the effective MLW width.
   If the target MLW width is greater than an HPR width in effect from the local Port, then schedule a Nak MLW.
LPMLW_S2 (2015)—An MLW is in effect from the link partner. After the third Ack MLW DLP is sent, reset the timer tracking how long the MLW has been effect and enable the timer to count.
LPMLW_S3 (2020)—An MLW is in effect from the link partner and a new MLW was received from the link partner. Disable the timer counting how long the MLW has been in effect but keep the current MLW in effect.
   If no HPR is in effect from the local Port or if the new target MLW width is less than or equal to the HPR width in effect from the local Port, then schedule an Ack MLW and update the effect MLW width with the new width.
   If the new target MLW width is greater than an HPR width in effect from the local Port, then schedule a Nak MLW.

The conditions for transitioning between states are as follows:
Arc_AnyState_to_LPMLW_S0: A Reset or Recovery returns the state machine to the LPMLW S0 state.
Arc LPMLW_S0_to_LPMLW_S1: Receiving an MLW from the link partner triggers this transition.
Arc LPMLW_S1_to_LPMLW_S0: Transmitting a Nak MLW triggers this transition.
Arc LPMLW_S1_to_LPMLW_S2: Transmitting an Ack MLW triggers this transition.
Arc LPMLW S2_to_LPMLW_S3: Receiving an MLW from the link partner triggers this transition.
Arc LPMLW_S3_to_LPMLW_S2: Transmitting an Ack MLW triggers this transition.
Arc LPMLW S3_to_LPMLW_S0: Transmitting a Nak MLW triggers this transition. Note that this means that the MLW currently in effect will no longer be honored either.
Arc LPMLW S2_to_LPMLW_S0: This transition is triggered if current MLW has been in effect for more than 2 ms and a new MLW is not received or if an HPR is transmitted with a target HPR width that is smaller than the MLW width in effect.

While the examples above pertain to PCIe-based protocols, it should be appreciated that these examples are presented to illustrate more generalized principles and features, which may be applied to other interconnect protocols including Compute Express Link (CXL), NVLink, Universal Chiplet Interconnect Express (UCIe), Ultra Path Interconnect (UPI), Infinity Fabric, among other example protocols. Note further that the apparatus,' methods,' and systems described above may be implemented in any electronic device or system as aforementioned. As specific illustrations, the figures below provide exemplary systems for utilizing the concepts as described herein. As the systems below are described in more detail, a number of different interconnects are disclosed, described, and revisited from the discussion above. And as is readily apparent, the advances described above may be applied to any of those interconnects, fabrics, or architectures.

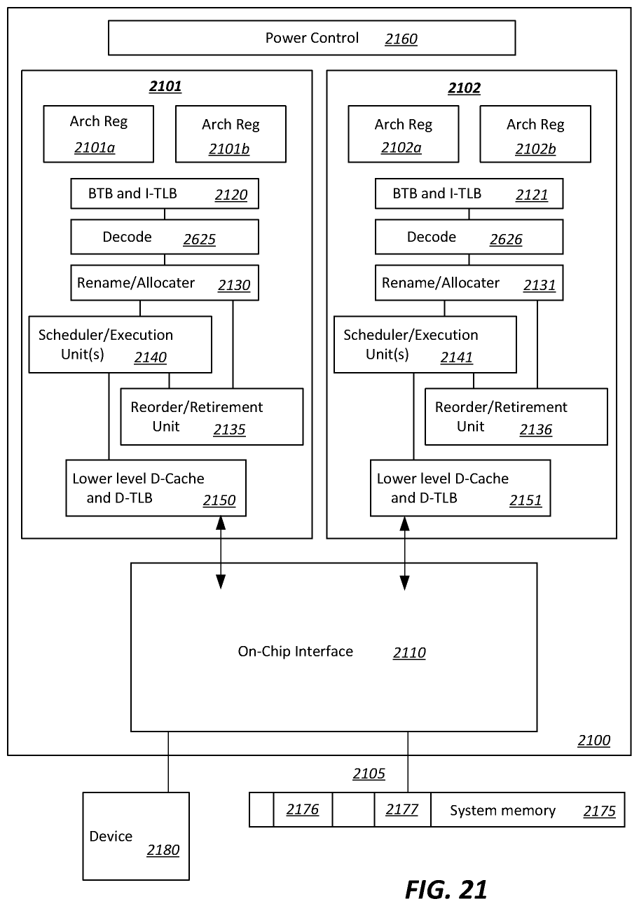

Referring to FIG. 21, an embodiment of a block diagram for a computing system including a multicore processor is depicted. Processor 2100 includes any processor or processing device, such as a microprocessor, an embedded processor, a digital signal processor (DSP), a network processor, a handheld processor, an application processor, a co-processor, a system on a chip (SOC), or other device to execute code. Processor 2100, in one embodiment, includes at least two cores-core 2101 and 2102, which may include asymmetric cores or symmetric cores (the illustrated embodiment). However, processor 2100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 2100, as illustrated in FIG. 21, includes two cores-core 2101 and 2102. Here, core 2101 and 2102 are considered symmetric cores, e.g., cores with the same configurations, functional units, and/or logic. In another embodiment, core 2101 includes an out-of-order processor core, while core 2102 includes an in-order processor core. However, cores 2101 and 2102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (e.g., asymmetric cores), some form of translation, such as a binary translation, may be utilized to schedule or execute code on one or both cores. Yet to further the discussion, the functional units illustrated in core 2101 are described in further detail below, as the units in core 2102 operate in a similar manner in the depicted embodiment.

As depicted, core 2101 includes two hardware threads 2101a and 2101b, which may also be referred to as hardware thread slots 2101a and 2101b. Therefore, software entities, such as an operating system, in one embodiment potentially view processor 2100 as four separate processors, e.g., four logical processors or processing elements capable of executing four software threads concurrently. As alluded to above, a first thread is associated with architecture state registers 2101a, a second thread is associated with architecture state registers 2101b, a third thread may be associated with architecture state registers 2102a, and a fourth thread may be associated with architecture state registers 2102b. Here, each of the architecture state registers (e.g., 2101a, 2101b, 2102a, and 2102b) may be referred to as processing elements, thread slots, or thread units, as described above. As illustrated, architecture state registers 2101a are replicated in architecture state registers 2101b, so individual architecture states/contexts are capable of being stored for logical processor 2101a and logical processor 2101b. In core 2101, other smaller resources, such as instruction pointers and renaming logic in allocator and renamer block 2130 may also be replicated for threads 2101a and 2101b. Some resources, such as re-order buffers in reorder/retirement unit 2135, ILTB 2120, load/store buffers, and queues may be shared through partitioning. Other resources, such as general purpose internal registers, page-table base register(s), low-level data-cache, and data-TLB 2115, execution unit(s) 2140, and portions of out-of-order unit 2135 are potentially fully shared.

Processor 2100 often includes other resources, which may be fully shared, shared through partitioning, or dedicated by/to processing elements. In FIG. 21, an embodiment of a purely exemplary processor with illustrative logical units/resources of a processor is illustrated. Note that a processor may include, or omit, any of these functional units, as well as include any other known functional units, logic, or firmware not depicted. As illustrated, core 2101 includes a simplified, representative out-of-order (OOO) processor core. But an in-order processor may be utilized in different embodiments. The OOO core includes a branch target buffer 2120 to predict branches to be executed/taken and an instruction-translation buffer (I-TLB) 2120 to store address translation entries for instructions.

Core 2101 further includes decode module 2125 coupled to fetch unit 2120 to decode fetched elements. Fetch logic, in one embodiment, includes individual sequencers associated with thread slots 2101a, 2101b, respectively. Usually core 2101 is associated with a first ISA, which defines/specifies instructions executable on processor 2100. Often machine code instructions that are part of the first ISA include a portion of the instruction (referred to as an opcode), which references/specifies an instruction or operation to be performed. Decode logic 2125 includes circuitry that recognizes these instructions from their opcodes and passes the decoded instructions on in the pipeline for processing as defined by the first ISA. For example, as discussed in more detail below decoders 2125, in one embodiment, include logic designed or adapted to recognize specific instructions, such as transactional instruction. As a result of the recognition by decoders 2125, the architecture or core 2101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 2126, in one embodiment, recognize the same ISA (or a subset thereof). Alternatively, in a heterogeneous core environment, decoders 2126 recognize a second ISA (either a subset of the first ISA or a distinct ISA).

In one example, allocator and renamer block 2130 includes an allocator to reserve resources, such as register files to store instruction processing results. However, threads 2101a and 2101b are potentially capable of out-of-order execution, where allocator and renamer block 2130 also reserves other resources, such as reorder buffers to track instruction results. Unit 2130 may also include a register renamer to rename program/instruction reference registers to other registers internal to processor 2100. Reorder/retirement unit 2135 includes components, such as the reorder buffers mentioned above, load buffers, and store buffers, to support out-of-order execution and later in-order retirement of instructions executed out-of-order.

Scheduler and execution unit(s) block 2140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 2150 are coupled to execution unit(s) 2140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 2101 and 2102 share access to higher-level or further-out cache, such as a second level cache associated with on-chip interface 2110. Note that higher-level or further-out refers to cache levels increasing or getting further away from the execution unit(s). In one embodiment, higher-level cache is a last-level data cache—last cache in the memory hierarchy on processor 2100—such as a second or third level data cache. However, higher level cache is not so limited, as it may be associated with or include an instruction cache. A trace cache—a type of instruction cache—instead may be coupled after decoder 2125 to store recently decoded traces. Here, an instruction potentially refers to a macro-instruction (e.g., a general instruction recognized by the decoders), which may decode into a number of micro-instructions (micro-operations).

In the depicted configuration, processor 2100 also includes on-chip interface module 2110. Historically, a memory controller, which is described in more detail below, has been included in a computing system external to processor 2100. In this scenario, on-chip interface 2110 is to communicate with devices external to processor 2100, such as system memory 2175, a chipset (often including a memory controller hub to connect to memory 2175 and an I/O controller hub to connect peripheral devices), a memory controller hub, a northbridge, or other integrated circuit. And in this scenario, bus 2105 may include any known interconnect, such as multi-drop bus, a point-to-point interconnect, a serial interconnect, a parallel bus, a coherent (e.g., cache coherent) bus, a layered protocol architecture, a differential bus, and a GTL bus.

Memory 2175 may be dedicated to processor 2100 or shared with other devices in a system. Common examples of types of memory 2175 include DRAM, SRAM, non-volatile memory (NV memory), and other known storage devices. Note that device 2180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 2100. For example, in one embodiment, a memory controller hub is on the same package and/or die with processor 2100. Here, a portion of the core (an on-core portion) 2110 includes one or more controller(s) for interfacing with other devices such as memory 2175 or a graphics device 2180. The configuration including an interconnect and controllers for interfacing with such devices is often referred to as an on-core (or un-core configuration). As an example, on-chip interface 2110 includes a ring interconnect for on-chip communication and a high-speed serial point-to-point link 2105 for off-chip communication. Yet, in the SOC environment, even more devices, such as the network interface, co-processors, memory 2175, graphics processor 2180, and any other known computer devices/interface may be integrated on a single die or integrated circuit to provide small form factor with high functionality and low power consumption.

In one embodiment, processor 2100 is capable of executing a compiler, optimization, and/or translator code 2177 to compile, translate, and/or optimize application code 2176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, e.g., generally where syntactic processing, semantic processing, and some transformation/optimization may take place, and (2) a back-end, e.g., generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

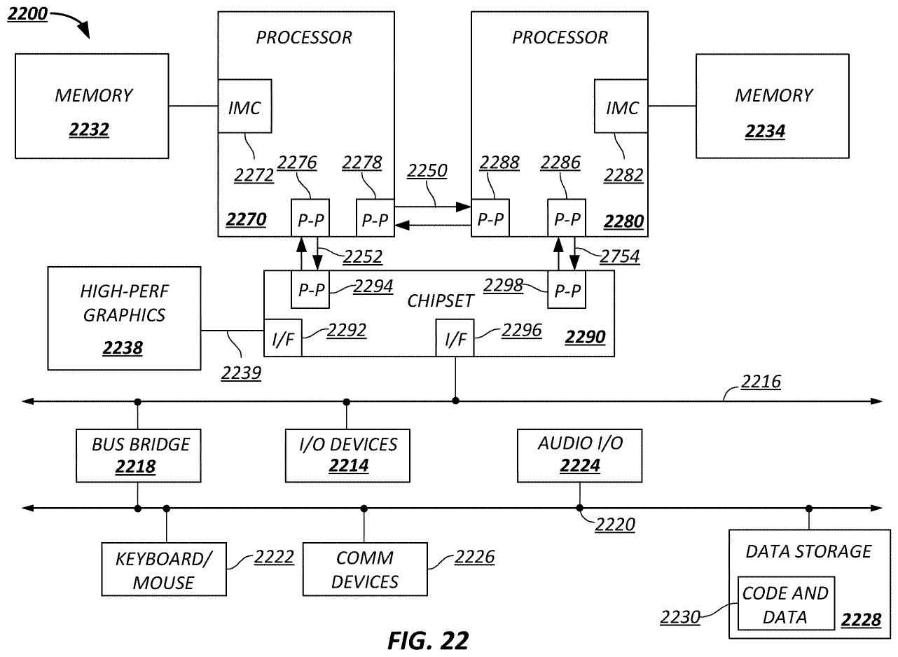

Referring now to FIG. 22, shown is a block diagram of a second system 2200 in accordance with an embodiment of the present disclosure. As shown in FIG. 22, multiprocessor system 2200 is a point-to-point interconnect system, and includes a first processor 2270 and a second processor 2280 coupled via a point-to-point interconnect 2250. Each of processors 2270 and 2280 may be some version of a processor. In one embodiment, 2252 and 2254 are part of a serial, point-to-point coherent interconnect fabric.

While shown with only two processors 2270, 2280, it is to be understood that the scope of the present disclosure is not so limited. In other embodiments, one or more additional processors may be present in a given processor.

Processors 2270 and 2280 are shown including integrated memory controller units 2272 and 2282, respectively. Processor 2270 also includes as part of its bus controller units point-to-point (P-P) interfaces 2276 and 2278; similarly, second processor 2280 includes P-P interfaces 2286 and 2288. Processors 2270, 2280 may exchange information via a point-to-point (P-P) interface 2250 using P-P interface circuits 2278, 2288. As shown in FIG. 22, IMCs 2272 and 2282 couple the processors to respective memories, namely a memory 2232 and a memory 2234, which may be portions of main memory locally attached to the respective processors.

Processors 2270, 2280 each exchange information with a chipset 2290 via individual P-P interfaces 2252, 2254 using point to point interface circuits 2276, 2294, 2286, 2298. Chipset 2290 also exchanges information with a high-performance graphics circuit 2238 via an interface circuit 2292 along a high-performance graphics interconnect 2239 (e.g., which may also incorporate the interconnect and debug reporting features described above).

A shared cache (not shown) may be included in either processor or outside of both processors; yet connected with the processors via P-P interconnect, such that either or both processors' local cache information may be stored in the shared cache if a processor is placed into a low power mode.

Chipset 2290 may be coupled to a first bus 2216 via an interface 2296. In one embodiment, first bus 2216 may be a Peripheral Component Interconnect (PCI) bus, or a bus such as a PCI Express bus or another third generation I/O interconnect bus, although the scope of the present disclosure is not so limited.

As shown in FIG. 22, various I/O devices 2214 are coupled to first bus 2216, along with a bus bridge 2218 which couples first bus 2216 to a second bus 2220. In one embodiment, second bus 2220 includes a low pin count (LPC) bus. Various devices are coupled to second bus 2220 including, for example, a keyboard and/or mouse 2222, communication devices 2227 and a storage unit 2228 such as a disk drive or other mass storage device which often includes instructions/code and data 2230, in one embodiment. Further, an audio I/O 2224 is shown coupled to second bus 2220. Note that other architectures are possible, where the included components and interconnect architectures vary. For example, instead of the point-to-point architecture of FIG. 22, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the solutions described above may be implemented in any portion of one or more of the interconnects illustrated or described below.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. The processor(s) may include any suitable processing unit, such as those based on x86, ARM, RISC-V, or other architectures. Examples include Intel® Core™ processors, AMD Ryzen® or EPYC® processors, Apple® M-series processors, Qualcomm® Snapdragon™ processors, or equivalents. The processor(s) may be part of a system-on-chip (SoC), system-in-package (SiP), or other integrated configurations. Other suitable processors now known or later developed may also be used. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP), or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via an SSD. However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by an SSD alone or as a disk, optical or other drive with an SSD cache. In some embodiments, the mass storage is implemented as an SSD or as an HDD along with a restore (RST) cache module. In various implementations, the HDD provides for storage of between 320 GB-4 terabytes (TB) and upward while the RST cache is implemented with an SSD having a capacity of 24 GB-256 GB. Note that such SSD cache may be configured as a single level cache (SLC) or multi-level cache (MLC) option to provide an appropriate level of responsiveness. In an SSD-only option, the module may be accommodated in various locations such as in a mSATA or NGFF slot. As an example, an SSD has a capacity ranging from 120 GB-1 TB.

While the concepts above have been described with respect to a limited number of embodiments, those skilled in the art will appreciate numerous modifications and variations therefrom. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing, and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The following examples pertain to embodiments in accordance with this Specification. Example 1 is an apparatus including: a port to couple to another device over an interconnect, where the port includes circuitry to: generate a request to change a link width of a link, where the link includes a bidirectional link and includes a first link direction to send data to the other device and a second link direction to receive data from the other device; send the request to the other device over the interconnect; and send a signal on a subset of lanes of the link in the first link direction in association with the request to change the link width of the link, where the subset of lanes are to be added to or subtracted from the link width of the link based on the request.

Example 2 includes the subject matter of example 1, where the request includes an asymmetric link width (ALW) request.

Example 3 includes the subject matter of example 2, where the ALW request requests a downsize of the link width and the signal includes an electrical idle ordered set associated with subtraction of the subset of lanes from the link width.

Example 4 includes the subject matter of example 3, where the port is further to receive an acknowledgement or negative acknowledgement from the other device to the ALW request.

Example 5 includes the subject matter of example 2, where the ALW request requests an upsize of the link width and the signal includes an electrical idle ordered set and a start of data sequence (SDS) associated with addition of the subset of lanes to the link width.

Example 6 includes the subject matter of example 5, where the port is to receive an acknowledgement and an upsize complete message from the other device before sending the SDS.

Example 7 includes the subject matter of example 1, where the request includes a high priority request (HPR) to cause the link width to be downsized.

Example 8 includes the subject matter of any one of examples 1-7, further including logic to determine a bandwidth for use in the first link direction, where the request is based on the bandwidth.

Example 9 includes the subject matter of any one of examples 1-8, where the circuitry is further to receive a minimum link width (MLW) request from the other device to indicate a minimum link width for a receiver of the other device, where the change to the link width of the link is based on the MLW request.

Example 10 includes the subject matter of any one of examples 1-9, where the circuitry is further to send data on the link in accordance with the changed link width of the link.

Example 11 includes the subject matter of any one of examples 1-10, where the request is defined in accordance with an interconnect protocol.

Example 12 includes the subject matter of example 11, where the protocol includes a Peripheral Component Interconnect Express (PCIe)-based protocol.

Example 13 includes the subject matter of example 12, where the protocol includes a flit mode of the PCIe protocol.

Example 14 includes the subject matter of example 11, where the protocol includes one of a CXL protocol, a UCIe protocol, or a NVLink protocol.

Example 15 includes the subject matter of any one of examples 1-14, where the change to the link width of the link in the first link direction is asymmetric with link width of the link in the second link direction.

Example 16 is a method including: identifying a bandwidth to be applied to a first direction of a link, where the link couples a first device to a second device, and the link is bidirectional and includes a first link direction to send data from the first device to the second device and a second link direction to send data from the second device to the first device; generating a request to change link width in the first link direction based on the bandwidth; sending the request from the first device to the second over the link using lanes of the first link direction; sending a signal on a subset of lanes of the link in the first link direction in association with the request to change the link width of the link, where the subset of lanes are to be added to or subtracted from the link width of the link based on the request; and sending data from the first device to the second device on the link based on the change to the link width of the link.

Example 17 includes the subject matter of example 16, where the change to the link width of the link in the first link direction is asymmetric with link width of the link in the second link direction.

Example 18 includes the subject matter of any one of examples 16-17, where the request includes an asymmetric link width (ALW) request.

Example 19 includes the subject matter of example 18, where the ALW request requests a downsize of the link width and the signal includes an electrical idle ordered set.

Example 20 includes the subject matter of example 19, where the port is further to receive an acknowledgement or negative acknowledgement from the other device to the ALW request.

Example 21 includes the subject matter of example 18, where the ALW request requests an upsize of the link width and the signal includes an electrical idle ordered set and a start of data sequence (SDS).

Example 22 includes the subject matter of example 21, where the port is to receive an acknowledgement and an upsize complete message from the other device before sending the SDS.

Example 23 includes the subject matter of any one of examples 16-17, where the request includes a high priority request (HPR) to cause the link width to be downsized.

Example 24 includes the subject matter of any one of examples 16-23, further including logic to determine a bandwidth for use in the first link direction, where the request is based on the bandwidth.

Example 25 includes the subject matter of any one of examples 16-24, where the circuitry is further to receive a minimum link width (MLW) request from the other device to indicate a minimum link width for a receiver of the other device, where the change to the link width of the link is based on the MLW request.

Example 26 includes the subject matter of any one of examples 16-25, where the circuitry is further to send data on the link in accordance with the changed link width of the link.

Example 27 includes the subject matter of any one of examples 16-26, where the request is defined in accordance with an interconnect protocol.

Example 28 includes the subject matter of example 27, where the protocol includes a Peripheral Component Interconnect Express (PCIe)-based protocol.

Example 29 includes the subject matter of example 28, where the protocol includes a flit mode of the PCIe protocol.

Example 30 includes the subject matter of example 27, where the protocol includes one of a CXL protocol, a UCIe protocol, or a NVLink protocol.

Example 31 is a system including means to perform the method of any one of examples 16-30.

Example 32 includes the subject matter of example 31, where the means include the circuitry of the apparatus of any one of examples 1-15.

Example 33 includes the subject matter of example 31, where the means includes a non-transitory machine-readable storage medium with instructions stored thereon, the instructions executable by a machine to cause the machine to perform at least a portion of the method of any one of examples 16-30.

Example 34 is a system including: a first device; and a second device coupled to the first device by an interconnect, where the second device includes a port to couple to the interconnect, and the port includes circuitry to: generate a request to change a link width of a link, where the link includes a bidirectional link and includes first link direction to send data to the first device and a second link direction to receive data from the first device; send the request to the first device over the interconnect; and send a signal on a subset of lanes of the link in the first link direction in association with the request to change the link width of the link, where the subset of lanes are to be added to or subtracted from the link width of the link based on the request.

Example 35 includes the subject matter of example 34, where the request includes an asymmetric link width (ALW) request.

Example 36 includes the subject matter of example 35, where the ALW request requests a downsize of the link width and the signal includes an electrical idle ordered set.

Example 37 includes the subject matter of example 36, where the port is further to receive an acknowledgement or negative acknowledgement from the first device to the ALW request.

Example 38 includes the subject matter of example 35, where the ALW request requests an upsize of the link width and the signal includes an electrical idle ordered set and a start of data sequence (SDS).

Example 39 includes the subject matter of example 38, where the port is to receive an acknowledgement and an upsize complete message from the first device before sending the SDS.

Example 40 includes the subject matter of example 34, where the request includes a high priority request (HPR) to cause the link width to be downsized.

Example 41 includes the subject matter of any one of examples 34-40, further including logic to determine a bandwidth for use in the first link direction, where the request is based on the bandwidth.

Example 42 includes the subject matter of any one of examples 34-41, where the circuitry is further to receive a minimum link width (MLW) request from the first device to indicate a minimum link width for a receiver of the first device, where the change to the link width of the link is based on the MLW request.

Example 43 includes the subject matter of any one of examples 34-42, where the circuitry is further to send data on the link in accordance with the changed link width of the link.

Example 44 includes the subject matter of any one of examples 34-43, where the request is defined in accordance with an interconnect protocol.

Example 45 includes the subject matter of example 44, where the protocol includes a Peripheral Component Interconnect Express (PCIe)-based protocol.

Example 46 includes the subject matter of example 45, where the protocol includes a flit mode of the PCIe protocol.

Example 47 includes the subject matter of example 46, where the protocol includes one of a CXL protocol, a UCIe protocol, or a NVLink protocol.

Example 48 includes the subject matter of any one of examples 34-47, where the change to the link width of the link in the first link direction is asymmetric with link width of the link in the second link direction.

Example 49 includes the subject matter of any one of examples 34-48, where at least one of the first device or the second device includes a host processor device.

Example 50 includes the subject matter of any one of examples 34-48, where at least one of the first device or the second device includes a graphics processor device.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a port to couple to a device over an interconnect, wherein the port comprises circuitry to:
generate a request to change a link width of a link, wherein the link comprises a bidirectional link and comprises a first link direction to send data to the device and a second link direction to receive data from the device;
send the request to the device over the interconnect; and
send a signal on a subset of lanes of the link in the first link direction in association with the request to change the link width of the link, wherein the subset of lanes are to be added to or subtracted from the link width of the link based on the request.

2. The apparatus of claim 1, wherein the request comprises an asymmetric link width (ALW) request.

3. The apparatus of claim 2, wherein the ALW request requests a downsize of the link width and the signal comprises an electrical idle ordered set associated with subtraction of the subset of lanes from the link width.

4. The apparatus of claim 3, wherein the port is further to receive an acknowledgement or negative acknowledgement from the device to the ALW request.

5. The apparatus of claim 2, wherein the ALW request requests an upsize of the link width and the signal comprises an electrical idle ordered set and a start of data sequence (SDS) associated with addition of the subset of lanes to the link width.

6. The apparatus of claim 5, wherein the port is to receive an acknowledgement and an upsize complete message from the device before sending the SDS.

7. The apparatus of claim 1, wherein the request comprises a high priority request (HPR) to cause the link width to be downsized.

8. The apparatus of claim 1, wherein the circuitry is to receive a minimum link width (MLW) request from the device to indicate a minimum link width for a receiver of the device, wherein the change to the link width of the link is based on the MLW request.

9. The apparatus of claim 1, wherein the circuitry is to send data on the link in accordance with the changed link width of the link.

10. The apparatus of claim 1, wherein the request is defined in accordance with an interconnect protocol.

11. The apparatus of claim 10, wherein the protocol comprises a Peripheral Component Interconnect Express (PCIe)-based protocol.

12. The apparatus of claim 11, wherein the protocol comprises a flit mode of the PCIe-based protocol.

13. A method comprising:
identifying a bandwidth to be applied to a first direction of a link, wherein the link couples a first device to a second device, and the link is bidirectional and comprises a first link direction to send data from the first device to the second device and a second link direction to send data from the second device to the first device;
generating a request to change link width in the first link direction based on the bandwidth;
sending the request from the first device to the second device over the link using lanes of the first link direction;
sending a signal on a subset of lanes of the link in the first link direction in association with the request to change the link width of the link, wherein the subset of lanes are to be added to or subtracted from the link width of the link based on the request; and
sending data from the first device to the second device on the link based on the change to the link width of the link.

14. The method of claim 13, wherein the change to the link width of the link in the first link direction is asymmetric with link width of the link in the second link direction.

15. The method of claim 13, wherein identifying the bandwidth to be applied to the first direction of the link comprises receiving a minimum link width (MLW) request from the second device to indicate a minimum link width for a receiver of the second device, wherein the change to the link width of the link is based on the MLW request.

16. A system comprising:
a first device; and
a second device coupled to the first device by an interconnect, wherein the second device comprises a port to couple to the interconnect, and the port comprises circuitry to:
generate a request to change a link width of a link, wherein the link comprises a bidirectional link and comprises first link direction to send data to the first device and a second link direction to receive data from the first device;
send the request to the first device over the interconnect; and
send a signal on a subset of lanes of the link in the first link direction in association with the request to change the link width of the link, wherein the subset of lanes are to be added to or subtracted from the link width of the link based on the request.

17. The system of claim 16, wherein the request is defined in accordance with a Peripheral Component Interconnect Express (PCIe)-based protocol.

18. The system of claim 16, wherein the signal comprises an electrical idle ordered set.

19. The system of claim 16, wherein at least one of the first device or the second device comprises a host processor device.

20. The system of claim 16, wherein at least one of the first device or the second device comprises a graphics processor device.
